(19) United States
(12) Patent Application Publication
(10) Pub. No.: US 2023/0392038 A1
(43) Pub. Date: Dec. 7, 2023

(54) COMPOSITION, BASE MATERIAL WITH SURFACE LAYER AND METHOD FOR PRODUCING BASE MATERIAL WITH SURFACE LAYER

(71) Applicant: AGC Inc., Tokyo (JP)

(72) Inventors: Kazumi KOUDA, Tokyo (JP); Takafumi KAWAKAMI, Tokyo (JP); Eiichiro ANRAKU, Tokyo (JP); Keigo MATSUURA, Tokyo (JP); Makoto UNO, Tokyo (JP)

(73) Assignee: AGC Inc., Tokyo (JP)

(21) Appl. No.: 18/451,448

(22) Filed: Aug. 17, 2023

Related U.S. Application Data
(63) Continuation of application No. PCT/JP2022/008607, filed on Mar. 1, 2022.

(30) Foreign Application Priority Data
Mar. 5, 2021 (JP) 2021-035376

(51) Int. Cl. C09D 171/02; C09D 5/00; C09D 7/63; C08G 65/22; C08G 65/336; C08K 5/5419

(52) U.S. Cl. CPC C09D 171/02; C09D 5/00; C09D 7/63; C08G 65/226; C08G 65/336; C08K 5/5419

(57) ABSTRACT

The object is to provide a composition capable of forming a surface layer excellent in abrasion resistance, a base material with the surface layer, and a method for producing the base material with the surface layer. The composition of the present invention comprises a fluorinated ether compound having a poly(oxyfluoroalkylene) chain and a reactive silyl group, and a crosslinking agent having a plurality of reactive silyl groups and no poly(oxyfluoroalkylene) chain.

### TECHNICAL FIELD

The present invention relates to a composition, a base material with a surface layer, and a method for producing a base material with a surface layer.

### BACKGROUND ART

In order to impart water and oil repellency, fingerprint stain removability, lubricity (smoothness when touched with a finger), etc. to the surface of a base material, it is known to form a surface layer consisting of a condensation product of a fluorinated ether compound on the surface of the base material by surface treatment using a fluorinated ether compound having a poly(oxyperfluoroalkylene) chain and a hydrolyzable silyl group (Patent Document 1).

### PRIOR ART DOCUMENT

### Patent Document

Patent Document 1: JP-A-2016-037541

### DISCLOSURE OF INVENTION

### Technical Problem

In recent years, the performance requirements for a surface layer formed by using a fluorinated ether compound have been increasing. For example, when the surface layer is applied to a component that constitutes a surface that is touched by a finger, a surface layer excellent in abrasion resistance is required, i.e. a surface layer whose performance (e.g. water repellency) does not deteriorate easily even after repeated abrasion.

When the present inventors evaluated a surface layer formed by using a fluorinated ether compound such as one described in Patent Document 1, they found that there was room for improvement in the abrasion resistance of the surface layer.

Therefore, the present invention is concerned with providing a composition capable of forming a surface layer excellent in abrasion resistance, a base material with the surface layer, and a method for producing the base material with the surface layer.

### Solution to Problem

The present inventors have found it possible to solve the above problem by the following construction.

[1] A composition characterized by comprising a fluorinated ether compound having a poly(oxyfluoroalkylene) chain and a reactive silyl group, and a crosslinking agent having a plurality of reactive silyl groups and no poly(oxyfluoroalkylene) chain.
[2] The composition according to [1], wherein the number of the reactive silyl groups in the crosslinking agent is from 2 to 8.
[3] The composition according to [1] or [2], wherein the crosslinking agent is a compound represented by the formula (A):

R^{a1}-L^{a1}-C(—Y^{a1}-T^{a1})ₘ₁(—R^{a2})₃₋ₘ₁ Formula (A)
in the formula (A),
R^{a1} is a hydrogen atom, a halogen atom, an amino group, a hydroxy group, a reactive silyl group, -L^{a2}-C(—Y^{a2}-T^{a2})ₘ₂(—R^{a3})₃₋ₘ₂, R^{a4}C(O)NH—, R^{a4}S(O)₂O—, R^{a4}C(O)O— or a thiol group,
L^{a1} and L^{a2} are each independently a C₁₋₁₀ alkylene group which may have a fluorine atom,
Y^{a1} and Y^{a2} are each independently a C₂₋₁₀ alkylene group which may have a fluorine atom or an etheric oxygen atom between carbon-carbon atoms,
T^{a1} and T^{a2} are each independently a reactive silyl group,
R^{a2} and Ra^{a3} are each independently a C₁₋₁₀ alkyl group which may have a fluorine atom, or a hydrogen atom,
R^{a4} is a C₁₋₅ alkyl group which may have a fluorine atom,
m1 and m2 are each independently an integer of from 1 to 3,
provided that when m1 is 1, R^{a1} is a reactive silyl group or -L^{a2}-C(—Y^{a2}-T^{a2})ₘ₂(—R^{a3})₃₋ₘ₂.
   [4] The composition according to [3], wherein in the formula (A),
L^{a1} is a C₁₋₁₀ alkylene group not having a fluorine atom,
Y^{a1} is a C₂₋₁₀ alkylene group not having a fluorine atom or an etheric oxygen atom, and
R^{a2} is a C₁₋₁₀ alkyl group not having a fluorine atom, or a hydrogen atom.
   [5] The composition according to [3] or [4], wherein in the formula (A), m1 is 3.
   [6] The composition according to any one of [3] to [5], wherein in the formula (A), R^{a1} is -L^{a2}-C(—Y^{a2}-T^{a2})ₘ₂(—R^{a3})₃₋ₘ₂.
   [7] The composition according to [6], wherein in the formula (A),
L^{a2} is a C₁₋₁₀ alkylene group not having a fluorine atom,
Y^{a2} is a C₂₋₁₀ alkylene group not having a fluorine atom or an etheric oxygen atom, and
R^{a3} is a C₁₋₁₀ alkyl group not having a fluorine atom, or a hydrogen atom.
   [8] The composition according to [6] or [7], wherein in the formula (A), m2 is 3.
   [9] The composition according to any one of [1] to [8], wherein the molar ratio of the content of the crosslinking agent to the content of the fluorinated ether compound is from 0.0010 to 0.3000.
   [10] The composition according to any one of [1] to [9], wherein the poly(oxyfluoroalkylene) chain contains a repeating unit represented by the following formula (1):

(OX) Formula (1)
(X is a fluoroalkylene group having at least one fluorine atom).
   [11] The composition according to any one of [1] to [10], wherein the reactive silyl group is a group represented by the following formula (2):

—Si(R)ₙL₃₋ₙ Formula (2)
(R is a monovalent hydrocarbon group; L is a hydrolyzable group or a hydroxy group; and n is an integer of from 0 to 2).
   [12] The composition according to any one of [1] to [11], wherein the fluorinated ether compound is a compound represented by the following formula (3):

[A-(OX)ₘ—O—]ⱼZ[—Si(R)ₙL₃₋ₙ]_{g} Formula (3)
(A is a perfluoroalkyl group or -Q[-Si(R)ₙL₃₋ₙ]ₖ; X is a fluoroalkylene group having at least one fluorine atom; R is a monovalent hydrocarbon group; L is a hydrolyzable group or a hydroxy group; m is an integer of at least 2; n is an integer of from 0 to 2; j is an integer of at least 1; g is an integer of at least 1; and k is an integer of from 1 to 10).
   [13] A base material with a surface layer, characterized by comprising a base material and a surface layer formed from the composition as defined in any one of [1] to on the base material.
   [14] A method for producing a base material with a surface layer, comprising forming a surface layer on the base material by a dry coating method or a wet coating method using the composition as defined in any one of [1] to [12].

### Advantageous Effects of Invention

According to the present invention, it is possible to provide a composition capable of forming a surface layer excellent in abrasion resistance, a base material with the surface layer, and a method for producing the base material with the surface layer.

In addition to this, according to the present invention, it is also possible to provide a composition capable of forming a surface layer excellent in abrasion resistance and at the same time forming a surface layer excellent in initial water contact angle, a base material with the surface layer, and a method of producing the base material with the surface layer.

### DESCRIPTION OF EMBODIMENTS

In the present specification, a compound represented by the formula (A) will be referred to as compound A. Compounds represented by other formulas will also be referred to in the same manner. A repeating unit represented by the formula (1) will be referred to as unit 1. Repeating units represented by other formulas will also be referred to in the same manner. A group represented by the formula (2) will be referred to as group 2. Groups represented by other formulas will also be referred to in the same manner. A compound represented by the formula (3) will be referred to as compound 3. Compounds represented by other formulas will also be referred to in the same manner.

In the present specification, in a case where “an alkylene group may have an A group”, the alkylene group may have an A group between carbon-carbon atoms in the alkylene group, or may have an A group at a terminal, as in alkylene group-A group-.

In the present specification, an “aryl group” in an “aryloxy group” includes not only an aryl group but also a heteroaryl group.

In the present specification, a “linking group” refers not only to a group of atoms, but also an atom itself may be treated as a “linking group” so long as it has the function of linking the prescribed groups. For example, a nitrogen atom itself is treated as a trivalent linking group.

The meanings of the terms in the present invention are as follows.

The “divalent organopolysiloxane residue” is a group represented by the following formula. RX in the following formula is an alkyl group (preferably C₁₋₁₀) or a phenyl group. Further, g1 is an integer of at least 1, preferably an integer of from 1 to 9, particularly preferably an integer of from 1 to 4.

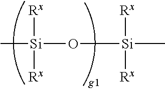

A “silphenylene backbone group” is a group represented by —Si(R^{y})₂PhSi(R^{y})₂— (where Ph is a phenylene group, and R^{y} is a monovalent organic group). R^{y} is preferably an alkyl group (preferably C₁₋₁₀).

A “dialkylsilylene group” is a group represented by —Si(R^{z})₂— (wherein R^{z} is an alkyl group, preferably C₁₋₁₀).

The “average molecular weight” of a compound is calculated by determining the number of oxyfluoroalkylene groups (average value) based on the terminal groups by ¹H-NMR and ¹⁹F-NMR.

### Composition

The composition of the present invention comprises a fluorinated ether compound having a poly(oxyfluoroalkylene) chain and a reactive silyl group (hereinafter referred to also as a “specific fluorinated ether compound”) and a crosslinking agent having a plurality of reactive silyl groups and no poly(oxyfluoroalkylene) chain.

The present inventors have found that when a surface layer is formed on a base material by using the composition of the present invention, the water repellency and abrasion resistance of the surface layer are improved. The details of the reason for this have not been clarified, but are assumed to be due to the following reason.

The surface layer to be obtained by using a fluorinated ether compound is formed by a hydrolysis decomposition reaction and a dehydration-condensation reaction of the reactive silyl groups of the fluorinated ether compound. Here, some of the reactive silyl groups of the fluorinated ether compound may remain without being bonded to the base material. In such a case, when the surface layer is rubbed, the molecules of the specific fluorinated ether compound having reactive silyl groups not bonded to the base material may peel off from the surface layer, and the abrasion resistance of the surface layer may decrease.

Here, it is considered that, if the composition of the present invention is used, some of the plurality of reactive silyl groups which the crosslinking agent has, will bond to reactive silyl groups in the specific fluorinated ether compound that are not bonded to the base material. Further, it is considered that some of the plurality of reactive silyl groups which the crosslinking agent has, will bond to the base material. It is thereby assumed to have the water repellency and abrasion resistance of the surface layer improved.

### Specific Fluorinated Ether Compound

The specific fluorinated ether compound is a compound having a poly(oxyfluoroalkylene) chain and a reactive silyl group.

The poly(oxyfluoroalkylene) chain contains a plurality of unit 1.

(OX) Formula (1)

X is a fluoroalkylene group having at least one fluorine atom.

The number of carbon atoms in the fluoroalkylene group is preferably from 2 to 6, particularly preferably from 2 to 4, from such a viewpoint that the weather resistance and corrosion resistance of the surface layer will be better.

The fluoroalkylene group may be linear, branched or cyclic.

The fluoroalkylene group has at least one fluorine atom, and from such a viewpoint that the corrosion resistance of the surface layer will be better, has preferably from 2 to 10 fluorine atoms, particularly preferably from 2 to 4 fluorine atoms.

The fluoroalkylene group may be a group in which all hydrogen atoms in the fluoroalkylene group are replaced by fluorine atoms (a perfluoroalkylene group).

As specific examples of unit 1, —OCHF—, —OCF₂CHF—, —OCHFCF₂—, —OCF₂CH₂—, —OCH₂CF₂—, —OCF₂CF₂CHF—, —OCHFCF₂CF₂—, —OCF₂CF₂CH₂—, —OCH₂CF₂CF₂—, —OCF₂CF₂CF₂CH₂—, —OCH₂CF₂CF₂CF₂—, —OCF₂CF₂CF₂CF₂CH₂—, —OCH₂CF₂CF₂CF₂CF₂—, —OCF₂CF₂CF₂CF₂CF₂CH₂—, —OCH₂CF₂CF₂CF₂CF₂CF₂—, —OCF₂—, —OCF₂CF₂—, —OCF₂CF₂CF₂—, —OCF(CF₃)CF₂—, —OCF₂CF₂CF₂CF₂—, —OCF(CF₃)CF₂CF₂—, —OCF₂CF₂CF₂CF₂CF₂—, —OCF₂CF₂CF₂CF₂CF₂CF₂—, —O-cycloC₄F₆—, —O-cycloC₅F₈—, and —O-cycloC₆F₁₀— may be mentioned.

Here, -cycloC₄F₆— means a perfluorocyclobutanediyl group, and as its specific example, a perfluorocyclobutane-1,2-diyl group may be mentioned. -cycloC₅F₈— means a perfluorocyclopentanediyl group, and as its specific example, a perfluorocyclopentane-1,3-diyl group may be mentioned. -cycloC₆F₁₀— means a perfluorocyclohexanediyl group, and as its specific example, a perfluorocyclohexane-1,4-diyl group may be mentioned.

The repeating number m of unit 1 in the poly(oxyfluoroalkylene) chain is an integer of at least 2, more preferably an integer of from 2 to 200, further preferably an integer of from 5 to 150, particularly preferably an integer of from 5 to 100, most preferably an integer of from 10 to 50.

The poly(oxyfluoroalkylene) chain may contain only one type of (OX) or may contain two or more types of (OX).

The bonding order of two or more types of (OX) is not limited and may be arranged at random, alternating, or in blocks.

“Contain two or more types of (OX)” means that in the specific fluorinated ether compound, two or more types of (OX) different in the number of carbon atoms are present, two or more types of (OX) different in the number of hydrogen atoms are present, two or more types of (OX) different in positions of hydrogen atoms are present, and two or more types of (OX) with the same number of carbon atoms but different in the presence or absence of side chains or in the type of side chains (number of side chains, number of carbon atoms in side chains, etc.), are present.

With respect to the arrangement of two or more types of (OX), for example, the structure represented by {(OCF₂)ₘ₂₁.(OCF₂CF₂)ₘ₂₂} shows that m21 (OCF₂) and m22 (OCF₂CF₂) are randomly arranged. Further, the structure represented by (OCF₂CF₂—OCF₂CF₂CF₂CF₂)ₘ₂₅ shows that m25 (OCF₂CF₂) and m25 (OCF₂CF₂CF₂CF₂) are alternately arranged.

As (OX)ₘ representing a poly(oxyfluoroalkylene) chain, [(OCHₘₐF₍₂₋ₘₐ₎)ₘ₁₁.(OC₂H_{mb}F_{(4-mb)})ₘ₁₂.(OC₃H_{mc}F_{(6-mc)})ₘ₁₃.(OC₄H_{md}F_{(8-md)})ₘ₁₄.(OC₅HₘₑF₍₁₀₋ₘₑ₎)ₘ₁₅.(OC₆H_{mf}F_{(12-mf)})ₘ₁₆.(O-cycloC₄H_{mg}F_{(6-mg)})ₘ₁₇.(O-cycloC₅HₘₕF₍₈₋ₘₕ₎)ₘ₁₈.(O-cycloC₆HₘᵢF₍₁₀₋ₘᵢ₎)ₘ₁₉)] is preferred. Here, -cycloC₄H_{mg}F_{(6-mg)} shows a fluorocyclobutanediyl group, and a fluorocyclobutane-1,2-diylgroup is preferred. -cycloC₅HₘₕF₍₈₋ₘₕ₎ shows a fluorocyclopentanediyl group, and a fluorocyclopentane-1,3-diyl group is preferred. -cycloC₆HₘᵢF₍₁₀₋ₘᵢ₎ shows a fluorocyclohexanediyl group, and a fluorocyclohexane-1,4-diylgroup is preferred.

ma is 0 or 1, mb is an integer of from 0 to 3, mc is an integer of from 0 to 5, and is an integer of from 0 to 7, me is an integer of from 0 to 9, mf is an integer of from 0 to 11, mg is an integer of from 0 to 5, mh is an integer of from 0 to 7, and mi is an integer of from 0 to 9.

m11, m12, m13, m14, m15, m16, m17, m18 and m19 are each independently an integer of at least 0, and preferably at most 100.

m11+m12+m13+m14+m15+m16+m17+m18+m19 is an integer of at least 2, more preferably an integer of from 2 to 200, further preferably an integer of from 5 to 150, still further preferably an integer of from 5 to 100, particularly preferably an integer of from 10 to 50.

Among them, m12 is preferably an integer of at least 2, particularly preferably an integer of from 2 to 200.

Further, C₃H_{mc}F_{(6-mc)}, C₄H_{md}F_{(8-md)}, C₅HₘₑF₍₁₀₋ₘₑ₎ and C₆H_{mf}F_{(12-mf)} may be linear or branched, and from such a viewpoint that the abrasion resistance of the surface layer will be better, are preferably linear.

Further, the bonding orders of m11 (OCHₘₐF₍₂₋ₘₐ₎), m12 (OC₂H_{mb}F_{(4-mb)}), m13 (OC₃H_{mc}F_{(6-mc)}), m14 (OC₄H_{md}F_{(8-md)}), m15 (OC₅HₘₑF₍₁₀₋ₘₑ₎), m16 (OC₆H_{mf}F_{(12-mf)}), m17 (O-cycloC₄H_{mg}F_{(6-mg)}), m18 (O-cycloC₅HₘₕF₍₈₋ₘₕ₎), and m19 (O-cycloC₆HₘᵢF₍₁₀₋ₘᵢ₎), are not limited.

In a case where m11 is at least 2, the plurality of (OCHₘₐF₍₂₋ₘₐ₎) may be the same or different.

In a case where m12 is at least 2, the plurality of (OC₂H_{mb}F_{(4-mb)}) may be the same or different.

In a case where m13 is at least 2, the plurality of (OC₃H_{mc}F_{(6-mc)}) may be the same or different.

In a case where m14 is at least 2, the plurality of (OC₄H_{md}F_{(8-md)}) may be the same or different.

In a case where m15 is at least 2, the plurality of (OC₅HₘₑF₍₁₀₋ₘₑ₎) may be the same or different.

In a case where m16 is at least 2, the plurality of (OC₆H_{mf}F_{(12-mf)}) may be the same or different.

In a case where m17 is at least 2, the plurality of (O-cycloC₄H_{mg}F_{(6-mg)}) may be the same or different.

In a case where m18 is at least 2, the plurality of (O-cycloC₅HₘₕF₍₈₋ₘₕ₎) may be the same or different.

In a case where m19 is at least 2, the plurality of (O-cycloC₆HₘᵢF₍₁₀₋ₘᵢ₎) may be the same or different.

As (OX)ₘ, ones having the following structures are preferred.
{(OCF₂)ₘ₂₁.(OCF₂CF₂)ₘ₂₂},
(OCF₂CF₂)ₘ₂₃,
(OCF₂CF₂CF₂)ₘ₂₄,
(OCF₂CF₂—OCF₂CF₂CF₂CF₂)ₘ₂₅,
{(OCF₂CF₂CF₂CF₂CF₂)ₘ₂₆.(OCF₂)ₘ₂₇},
{(CF₂CF₂CF₂CF₂CF₂)ₘ₂₆.(OCF₂CF₂)ₘ₂₇},
{(OCF₂CF₂CF₂CF₂CF₂CF₂)ₘ₂₆.(OCF₂)ₘ₂₇},
{(OCF₂CF₂CF₂CF₂CF₂CF₂)ₘ₂₆.(OCF₂CF₂)ₘ₂₇},
(OCF₂CF₂CF₂CF₂CF₂—OCF₂)ₘ₂₈,
(OCF₂CF₂CF₂CF₂CF₂—OCF₂CF₂)ₘ₂₈,
(OCF₂CF₂CF₂CF₂CF₂CF₂—OCF₂)ₘ₂₈,
(OCF₂CF₂CF₂CF₂CF₂CF₂—OCF₂CF₂)ₘ₂₈,
(OCF₂—OCF₂CF₂CF₂CF₂CF₂)ₘ₂₈,
(OCF₂—OCF₂CF₂CF₂CF₂CF₂CF₂)ₘ₂₈,
(OCF₂CF₂—OCF₂CF₂CF₂CF₂CF₂)ₘ₂₈,
(OCF₂CF₂—OCF₂CF₂CF₂CF₂CF₂CF₂)m₂₈.

Here, m21 is an integer of at least 1, m22 is an integer of at least 1, m21+m22 is an integer of from 2 to 500, m23 and m24 are each independently an integer of from 2 to 500, m25 is an integer of from 1 to 250, m26 and m27 are each independently an integer of at least 1, m26+m27 is an integer of from 2 to 500, and m28 is an integer of from 1 to 250.

As (OX)ₘ, ones having the following structures are more preferred from such a viewpoint that it will be easy to produce specific fluorinated ether compounds.
{(OCF₂)ₘ₂₁.(OCF₂CF₂)ₘ₂₂},
(OCF₂CF₂CF₂)ₘ₂₄,
(OCF₂CF₂)₂{(OCF₂)ₘ₂₁.(OCF₂CF₂)ₘ₂₂₋₂},
(OCF₂CF₂—OCF₂CF₂CF₂CF₂)ₘ₂₅₋₁OCF₂CF₂,
(OCF₂CF₂CF₂CF₂CF₂—OCF₂)ₘ₂₈,
(OCF₂CF₂CF₂CF₂CF₂CF₂—OCF₂)ₘ₂₈,
(OCF₂CF₂—OCF₂CF₂CF₂CF₂CF₂)ₘ₂₈₋₁OCF₂CF₂,
(OCF₂CF₂—OCF₂CF₂CF₂CF₂CF₂CF₂)ₘ₂₈₋₁OCF₂CF₂.

Here, with respect to m22-2, m25-1 and m28-1, the numbers for m22, m25 and m28 are selected so that they will be integers of at least 1.

Among these, (OX)ₘ is preferably {(OCF₂)ₘ₂₁.(OCF₂CF₂)ₘ₂₂} from such a viewpoint that the abrasion resistance of the surface layer will be better.

In {(OCF₂)ₘ₂₁.(OCF₂CF₂)ₘ₂₂}, m22/m21 is preferably from 0.1 to 10, more preferably from 0.2 to 5.0, further preferably from 0.2 to 2.0, particularly preferably from 0.2 to 1.5, most preferably from 0.2 to 0.85, from such a viewpoint that the abrasion resistance and fingerprint stain removability of the surface layer will be better.

The number average molecular weight of (OX)ₘ is preferably from 1,000 to 20,000, more preferably from 2,000 to 15,000, particularly preferably from 3,000 to 10,000.

When the number average molecular weight is at least the lower limit value, the molecular chain of the specific fluorinated ether compound becomes longer, whereby the flexibility of the molecular chain of the specific fluorinated ether compound will be improved. This increases the probability of reaction between the silanol group derived from the reactive silyl group of the specific fluorinated ether compound and the base material or undercoat layer having a silanol group, and thus the adhesiveness between the surface layer and the base material or undercoat layer will be further improved. As a result, the abrasion resistance of the surface layer will be more excellent. Further, the fluorine content of the surface layer will be improved, whereby the water and oil repellency will be better.

When the number average molecular weight is at most the upper limit value, the handling efficiency at the time of film deposition will be more excellent.

As the reactive silyl group, group 2 is preferred.

—Si(R)ₙL₃₋ₙ Formula (2)

R is a monovalent hydrocarbon group.

The monovalent hydrocarbon group is preferably a monovalent aliphatic hydrocarbon group (saturated or unsaturated) or a monovalent aromatic hydrocarbon group, more preferably a monovalent aliphatic hydrocarbon group, particularly preferably an alkyl group.

The monovalent hydrocarbon group may be linear, branched or cyclic, and is preferably linear or branched. The number of carbon atoms in the monovalent hydrocarbon group is preferably from 1 to 6, more preferably from 1 to 3, particularly preferably from 1 to 2.

L is a hydrolyzable group or a hydroxy group.

The hydrolyzable group of L is a group that becomes a hydroxy group by a hydrolysis reaction. That is, a silyl group having hydrolyzability represented by Si-L becomes a silanol group represented by Si—OH by a hydrolysis reaction. The silanol group further reacts with another silanol group to form a Si—O—Si bond.

As specific examples of L being a hydrolyzable group, an alkoxy group, an aryloxy group, a halogen atom, an acyl group, an acyloxy group, and an isocyanate group (—NCO) may be mentioned. As the alkoxy group, a C₁₋₄ alkoxy group is preferred. As the aryloxy group, a C₃₋₁₀ aryloxy group is preferred. As the halogen atom, a chlorine atom is preferred. As the acyl group, a C₁₋₆ acyl group is preferred. As the acyloxy group, a C₁₋₆ acyloxy group is preferred.

As L, from such a viewpoint that the production of the specific fluorinated ether compound will be easier, a C₁₋₄ alkoxy group or a halogen atom is preferred. As L, from such a viewpoint that outgas during application will be less, and the storage stability of the specific fluorinated ether compound will be better, a C₁₋₄ alkoxy group is preferred, and in a case where the storage stability for a long time of the specific fluorinated ether compound is required, an ethoxy group is particularly preferred, and in a case where the reaction time after coating is to be made short, a methoxy group is particularly preferred.

n is an integer of from 0 to 2.

n is preferably 0 or 1, particularly preferably 0. By the presence of a plurality of L, the adhesion of the surface layer to the base material will be stronger.

In a case where n is 0 or 1, the plurality of L present in one molecule may be the same or different. From the viewpoint of availability of raw materials and ease of production of the specific fluorinated ether compound, it is preferred that they are the same. In a case where n is 2, the plurality of R present in one molecule may be the same or different. From the viewpoint of availability of raw materials and ease of production of the specific ether compound, it is preferred that they are the same.

As the specific fluorinated ether compound, compound 3 is preferred, from such a viewpoint that it is superior in the water and oil repellency and the abrasion resistance of the film.

[A-(OX)ₘ—O—]ⱼZ[—Si(R)ₙL₃₋ₙ]_{g} Formula (3)

A is a perfluoroalkyl group or -Q[-Si(R)ₙL₃₋ₙ]ₖ.

The number of carbon atoms in the perfluoroalkyl group is preferably from 1 to 20, more preferably from 1 to 10, further preferably from 1 to 6, particularly preferably from 1 to 3, from such a viewpoint that the abrasion resistance of the film will be better.

The perfluoroalkyl group may be linear or branched.

However, in a case where A is -Q[-Si(R)ₙL₃₋ₙ]ₖ, j is 1.

As the perfluoroalkyl group, CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂—, CF₃CF(CF₃)—, etc., may be mentioned.

As the perfluoroalkyl group, CF₃—, CF₃CF₂— or CF₃CF₂CF₂— is preferred, from such a viewpoint that the water and oil repellency of the film will be better.

Q is a (k+1)-valent linking group. As will be described below, k is an integer of from 1 to 10. Therefore, as Q, a 2 to 11-valent linking group may be mentioned.

Q preferably has at least one type of branching point (hereinafter referred to as “branching point P”) selected from the group consisting of C, N, Si, a ring structure and a (k+1)-valent organopolysiloxane residue.

As the ring structure, from such viewpoints that the specific fluorinated ether compound can easily be produced, and the abrasion resistance, light resistance and chemical resistance of the surface layer will be better, at least one type selected from the group consisting of a 3 to 8 membered aliphatic ring, a 3 to 8 membered aromatic ring, a 3 to 8 membered hetero ring, and a condensed ring consisting of two or more of these rings, is preferred, and ring structures represented by the following formulas are particularly preferred.

The ring structures may have a substituent such as a halogen atom, an alkyl group (which may contain an etheric oxygen atom between carbon-carbon atoms), a cycloalkyl group, an alkenyl group, an allyl group, an alkoxy group, or an oxo group (═O).

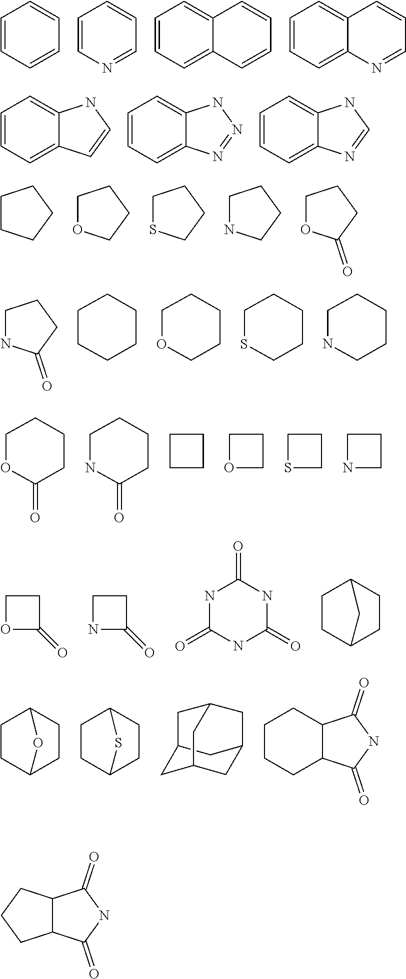

As specific examples of the (k+1)-valent organopolysiloxane residue, the following groups may be mentioned.

Here, R⁵ in the following formulas is a hydrogen atom, an alkyl group, an alkoxy group, or a phenyl group. The number of carbon atoms in the alkyl group and alkoxy group as R⁵ is preferably from 1 to 10, particularly preferably 1.

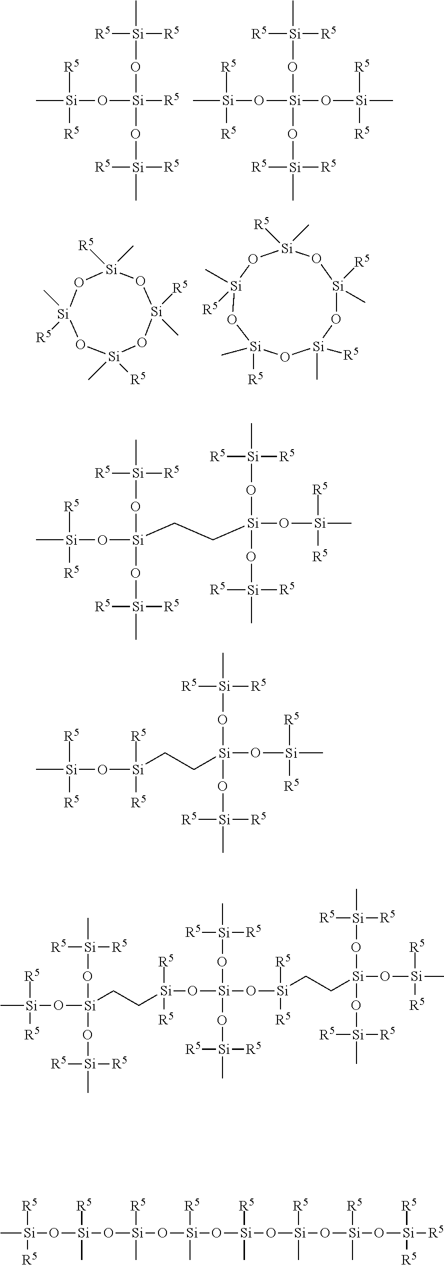

Q may have a group containing at least one type selected from an alkylene group, a fluoroalkylene group, a hydroxyalkylene group, an alkoxyalkylene group, a carbonyl group, an amide bond, an ether bond, a thioether bond, a urea bond, a urethane bond, a carbonate bond, an ester bond, —SO₂NR⁶—, —Si(R⁶)₂—, —OSi(R⁶)₂—, —Si(CH₃)₂-Ph-Si(CH₃)₂— and a divalent organopolysiloxane residue.

Here, R⁶ is a hydrogen atom, a C₁₋₆ alkyl group or a phenyl group, and Ph is a phenylene group. The number of carbon atoms in the alkyl group as R⁶ is preferably from 1 to 3, particularly preferably from 1 to 2, from such a viewpoint that the specific fluorinated ether compound can be easily produced.

Further, each bond or group constituting Q may have either terminal positioned on the [A-(OX)ₘ—O—]ⱼ side. For example, an amide bond may have a carbon atom positioned on the [A-(OX)ₘ—O—]ⱼ side, or a nitrogen atom on the [A-(OX)ₘ—O—]ⱼ side. The same applies to other bonds and groups.

As specific examples of the divalent organopolysiloxane residue, groups of the following formulas may be mentioned. Here, R⁷ in the following formulas is a hydrogen atom, an alkyl group, an alkoxy group, or a phenyl group, The number of carbon atoms in the alkyl group and alkoxy group as R⁷ is preferably from 1 to 10, particularly preferably 1.

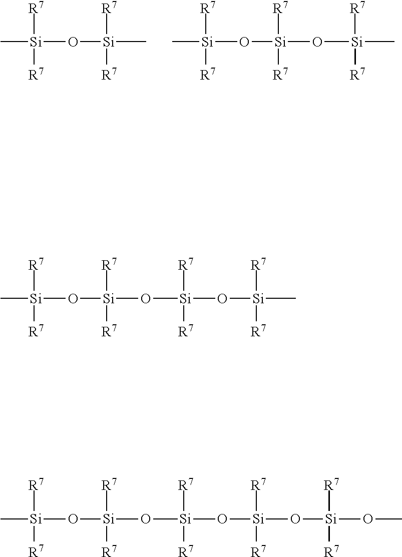

Q preferably has at least one type of bond selected from the group consisting of —C(O)NR⁶—, —C(O)—, —C(O)OR⁶—, —NR⁶— and —O—, from such a viewpoint that the specific fluorinated ether compound can easily be produced, and particularly preferably has —C(O)NR⁶— or —C(O)— from such a viewpoint that the light resistance and chemical resistance of the surface layer will be excellent.

As Q, a combination of two or more divalent hydrocarbon groups and one or more branching points P, or a combination of two or more hydrocarbon groups, one or more branching points P and one or more bonds B, may be mentioned.

As specific examples of the divalent hydrocarbon group, a divalent aliphatic hydrocarbon group (such as an alkylene group or a cycloalkylene group) and a divalent aromatic hydrocarbon group (such as a phenylene group) may be mentioned. The number of carbon atoms in the divalent hydrocarbon group is preferably from 1 to 10, more preferably from 1 to 6, particularly preferably from 1 to 4.

The definitions of R, L, n, X and m are as described in the description of the above-mentioned poly(oxyfluoroalkylene) chain and the above-mentioned reactive silyl group.

Z is a (j+g)-valent linking group.

The definition of Z is the same as that of the above-described Q, except that in the above-described Q, the (k+1) valence is read as a (j+g) valence. In the specific fluorinated ether compound, Z and Q may be the same or different. It is preferred that Z and Q be the same, from the viewpoint of ease of production of the specific fluorinated ether compound.

j is an integer of at least 1, preferably an integer of from 1 and 5 from such a viewpoint that the water and oil repellency of the film will be better, particularly preferably 1 from such a viewpoint that compound 3 can easily be produced.

g is an integer of at least 1, and from such a viewpoint that the abrasion resistance of the film will be better, preferably an integer of from 2 to 4, more preferably 2 or 3, particularly preferably 3.

k is an integer of from 1 to 10, and from such a viewpoint that the abrasion resistance of the surface layer will be better, preferably an integer of from 1 to 8, particularly preferably an integer of from 2 to 6.

As compound 3, from such a viewpoint that the initial water contact angle and abrasion resistance of the surface layer will be better, compound 3-11, compound 3-21 and compound 3-31 are preferred. Among them, compound 3-11 and compound 3-21 are particularly excellent in the initial water contact angle of the surface layer, and compound 3-31 is particularly excellent in the abrasion resistance of the surface layer.

R^{f1}—(OX)ₘ—O—Y¹¹[—Si(R)ₙL₃₋ₙ]_{g1} Formula (3-11)

[R^{f2}—(OX)ₘ—O—]ⱼ₂Y²¹[—Si(R)ₙL₃₋ₙ]_{g2} Formula (3-21)

[L₃₋ₙ(R)ₙSi—]ₖ₃Y³²—(OX)ₘ—O—Y³¹[—Si(R)ₙL₃₋ₙ]_{g3} Formula (3-31)

In the formula (3-11), X, m, R, n and L are, respectively, synonymous with the definitions of X, m, R, n and L in the formula (3).

R^{f1} is a perfluoroalkyl group, and suitable forms and specific examples of the perfluoroalkyl group are as described above.

Y¹¹ is a (g1+1)-valent linking group, of which specific examples are the same as Z in the formula (3).

g1 is an integer of at least 1, and from such a viewpoint that the abrasion resistance of the surface layer will be better, preferably an integer of from 2 to 15, more preferably an integer of from 2 to 4, further preferably 2 or 3, particularly preferably 3.

In the formula (3-21), X, m, R, n and L are, respectively, synonymous with the definitions of X, m, R, n and L in the formula (3).

R^{f2} is a perfluoroalkyl group, and suitable forms and specific examples of the perfluoroalkyl group are as described above.

j2 is an integer of at least 2, preferably an integer of from 2 to 6, more preferably an integer of from 2 to 4.

Y²¹ is a (j2+g2)-valent linking group, of which specific examples are the same as Z in the formula (3).

g2 is an integer of at least 1, and from such a viewpoint that the abrasion resistance of the surface layer will be better, preferably an integer of from 2 to 15, more preferably from 2 to 6, further preferably from 2 to 4, particularly preferably 4.

In the formula (3-31), X, m, R, n and L are, respectively, synonymous with the definitions of X, m, R, n and L in the formula (3).

k3 is an integer of at least 1, preferably an integer of from 1 to 4, more preferably 2 or 3, particularly preferably 3.

Y³² is a (k3+1)-valent linking group, of which specific examples are the same as Q in the formula (3).

Y³¹ is a (g3+1)-valent linking group, of which specific examples are the same as Z in the formula (3).

g3 is an integer of at least 1, preferably an integer of from 1 to 4, more preferably 2 or 3, particularly preferably 3.

Y¹¹ in the formula (3-11) may be group g2-1 (where d1+d3=1 (i.e. d1 or d3 is 0), g1=d2+d4, d2+d4≥1), group g2-2 (where e1=1, g1=e2, and e2≥1), group g2-3 (where g1=2), group g2-4 (where h1=1, g1=h2, h2≥1), group g2-5 (where i1=1, g1=i2, i2≥1), group g2-6 (where g1=1), group g2-7 (where g1=i3+1), group g2-8 (where g1=i4, i4≥1), or group g2-9 (where g1=i5, i5≥1).

Y²¹ in the formula (3-21) may be group g2-1 (where j2=d1+d3, d1+d3≥2, g2=d2+d4, d2+d4≥1), group g2-2 (where j2=e1, e1=2, g2=e2, e2≥1), group g2-4 (where j2=h1≥2, g2=h2, h2≥1) or group g2-5 (where j2=i1, i1=2, g2=i2, i2≥1).

Further, Y³¹ and Y³² in the formula (3-31) may each independently be group g2-1 (where g3=d2+d4 and k3=d2+d4), group g2-2 (where g3=e2 and k3=e2), group g2-3 (where g3=2, k3=2), group g2-4 (where g3=h2, k3=h2), group g2-5 (where g3=i2, k3=i2), group g2-6 (where g3=1, k3=1), group g2-7 (where g3=i3+1 and k3=i3+1), group g2-8 (where g3=i4 and k3=i4) or group g2-9 (where g3=i5 and k3=i5).

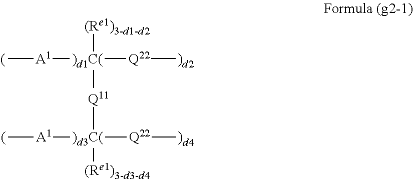

(-A¹-)ₑ₁C(R^{e2})₄₋ₑ₁₋ₑ₂(-Q²²-)ₑ₂ Formula (g2-2)

-A¹-N(-Q²³-)₂ Formula (g2-3)

(-A¹-)ₕ₁Z¹(-Q²⁴-)ₕ₂ Formula (g2-4)

(-A¹-)ᵢ₁Si(R^{e3})₄₋ᵢ₁₋ᵢ₂(-Q²⁵-)ᵢ₂ Formula (g2-5)

-A¹-Q²⁶- Formula (g2-6)

-A¹-CH(-Q²²-)-Si(R^{e3})₃₋ᵢ₃(-Q²⁵-)ᵢ₃ Formula (g2-7)

-A¹-[CH₂C(R^{e4})(-Q²⁷-)]ᵢ₄-R^{e5} Formula (g2-8)

-A¹-Z^{a}(-Q²⁸-)ᵢ₅ Formula (g2-9)

However, in the formula (g2-1) to the formula (g2-9), A¹ is bonded to the (OX)ₘ side, and Q²², Q²³, Q²⁴, Q²⁵, Q²⁶, Q²⁷ and Q²⁸ are bonded to the [—Si(R)ₙL₃₋ₙ] side.

A¹ is a single bond, an alkylene group, or a group having —C(O)NR⁶—, —C(O)—, —OC(O)O—, —NHC(O)O—, —NHC(O)NR⁶—, —O—, —SO₂NR⁶— or —N(R⁶)SO₂— between carbon-carbon atoms in an alkylene group with at least two carbon atoms, and in a case where at least two A¹ are present in each formula, such at least two A¹ may be the same or different. A hydrogen atom in the alkylene group may be replaced by a fluorine atom.

Q¹¹ is a single bond, —O—, an alkylene group, or a group having —C(O)NR⁶—, —C(O)—, —NR⁶— or —O— between carbon-carbon atoms in an alkylene group with at least two carbon atoms.

Q²² is an alkylene group, a group having —C(O)NR⁶—, —C(O)—, —NR⁶— or —O— between carbon-carbon atoms in an alkylene group with at least two carbon atoms, a group having —C(O)NR⁶—, —C(O)—, —NR⁶— or —O— at the terminal on the side not connected to Si in the alkylene group, or a group having —C(O)NR⁶—, —C(O)—, —NR⁶— or —O— between carbon-carbon atoms in an alkylene group with at least two carbon atoms, and having —C(O)NR⁶—, —C(O)—, —NR⁶— or —O— at the terminal on the side not connected to Si in the alkylene group, and in a case where in each formula, at least two Q²² are present, such at least two Q²² may be the same or different.

Q²³ is an alkylene group, or a group having —C(O)NR⁶—, —C(O)—, —NR⁶— or —O— between carbon-carbon atoms in an alkylene group with at least two carbon atoms, and such at least two Q²³ may be the same or different.

Q²⁴ is Q²² in a case where the atom at Z¹ to which Q²⁴ bonds is a carbon atom, and Q²³ in a case where the atom at Z¹ to which Q²⁴ bonds is a nitrogen atom, and in a case where in each formula, at least two Q²⁴ are present, such at least two Q²⁴ may be the same or different.

Q²⁵ is an alkylene group, or a group having —C(O)NR⁶—, —C(O)—, —NR⁶— or —O— between carbon-carbon atoms in an alkylene group with at least two carbon atoms, and in a case where in each formula, at least Q²⁵ are present, such at least two Q²⁵ may be the same or different.

Q²⁶ is an alkylene group, or a group having —C(O)NR⁶—, —C(O)—, —NR⁶— or —O— between carbon-carbon atoms in an alkylene group with at least two carbon atoms.

R⁶ is a hydrogen atom, a C₁₋₆ alkyl group, or a phenyl group.

Q²⁷ is a single bond or an alkylene group.

Q²⁸ is an alkylene group, or a group having an etheric oxygen atom or a divalent organopolysiloxane residue between carbon-carbon atoms in an alkylene group with at least two carbon atoms.

Z¹ is a group having an h1+h2-valent ring structure having a carbon atom or a nitrogen atom to which A¹ directly bonds and having a carbon atom or a nitrogen atom to which Q²⁴ directly bonds.

R^{e1} is a hydrogen atom or an alkyl group, and in a case where in each formula, at least two R^{e1} are present, such at least two R^{e1} may be the same or different.

R^{e2} is a hydrogen atom, a hydroxy group, an alkyl group or an acyloxy group.

R^{e3} is an alkyl group.

R^{e4} is a hydrogen atom or an alkyl group, and is preferably a hydrogen atom from such a viewpoint that the compound can easily be produced. In a case where in each formula, at least two R^{e4} are present, such at least two R^{e4} may be the same or different.

R^{e5} is a hydrogen atom or a halogen atom, and is preferably a hydrogen atom from such a viewpoint that the compound can easily produced.

d1 is an integer of from 0 to 3, preferably 1 or 2. d2 is an integer of from 0 to 3, preferably 1 or 2. d1+d2 is an integer of from 1 to 3.

d3 is an integer of from 0 to 3, preferably 0 or 1. d4 is an integer of from 0 to 3, preferably 2 or 3. d3+d4 is an integer of from 1 to 3.

d1+d3 is an integer of from 1 to 5, preferably 1 or 2, in Y²¹, and 1 in Y¹¹, Y³¹ and Y³².

d2+d4 is an integer of from 1 to 5, preferably 4 or 5, in Y¹¹ or Y²¹, and an integer of from 1 to 5, preferably an integer of from 3 to 5, particularly preferably 4 or 5, in Y³¹ and Y³².

e1+e2 is 3 or 4. e1 is 1 in Y¹¹, an integer of from 2 to 3 in Y²¹, and 1 in Y³¹ and Y³². e2 is from 1 to 3, preferably 2 or 3, in Y¹¹ or Y²¹, and from 1 to 3, preferably 2 or 3, in Y³¹ and Y³².

h1 is 1 in Y¹¹, an integer of at least 2 (preferably 2) in Y²¹, and 1 in Y³¹ and Y³². h2 is an integer of at least 1 (preferably 2 or 3) in Y¹¹ or Y²¹, and at least 1 (preferably 2 or 3) in Y³¹ and Y³².

i1+i2 is an integer of from 2 to 4 (preferably 3 or 4) in Y¹¹, 3 or 4 (preferably 4) in Y¹², and an integer of from 2 to 4 (preferably 3 or 4) in Y³¹ and Y³². i1 is 1 in Y¹¹, 2 or 3 in Y²¹, and 1 in Y³¹ and Y³². i2 is an integer of from 1 to 3 (preferably 2 or 3) in Y¹¹, 1 or 2 (preferably 2) in Y¹², and an integer of from 1 to 3 (preferably 2 or 3) in Y³¹ and Y³².

i3 is an integer of from 0 to 3, preferably from 1 to 3, particularly preferably 2 or 3.

i4 is at least 1 (preferably an integer of from 2 to 10, particularly preferably an integer of from 2 to 6) in Y¹¹ and at least 1 (preferably an integer of from 1 to 10, particularly preferably an integer of from 1 to 6) in Y³¹ and Y³².

i5 is at least 1 (preferably an integer of from 2 to 7) in Y¹¹, and at least 1 (preferably an integer of from 2 and 7) in Y³¹ and Y³².

The number of carbon atoms in the alkylene groups in Q²², Q²³, Q²⁴, Q²⁵, Q²⁶, Q²⁷, and Q²⁸ is preferably from 1 to 10, more preferably from 1 to 6, particularly preferably from 1 to 4, from such a viewpoint that compound 3-11, compound 3-21 and compound 3-31 can easily be produced, and the abrasion resistance, light resistance and chemical resistance of the surface layer will be better. However, the lower limit value of the number of carbon atoms in the alkylene group in the case of having a specific bond between carbon-carbon atoms, is 2.

As the ring structure at Z¹, the above-described ring structure may be mentioned, and the preferred form is also the same. Further, since A¹ and Q²⁴ are directly bonded to the ring structure in Z¹, there will be no such a case that, for example, an alkylene group is linked to the ring structure, and A¹ and Q²⁴ are linked to that alkylene group.

Z^{a} is a (i5+1)-valent organopolysiloxane residue, preferably the following groups. Here, R^{a} in the following formulas is an alkyl group (preferably C₁₋₁₀) or a phenyl group.

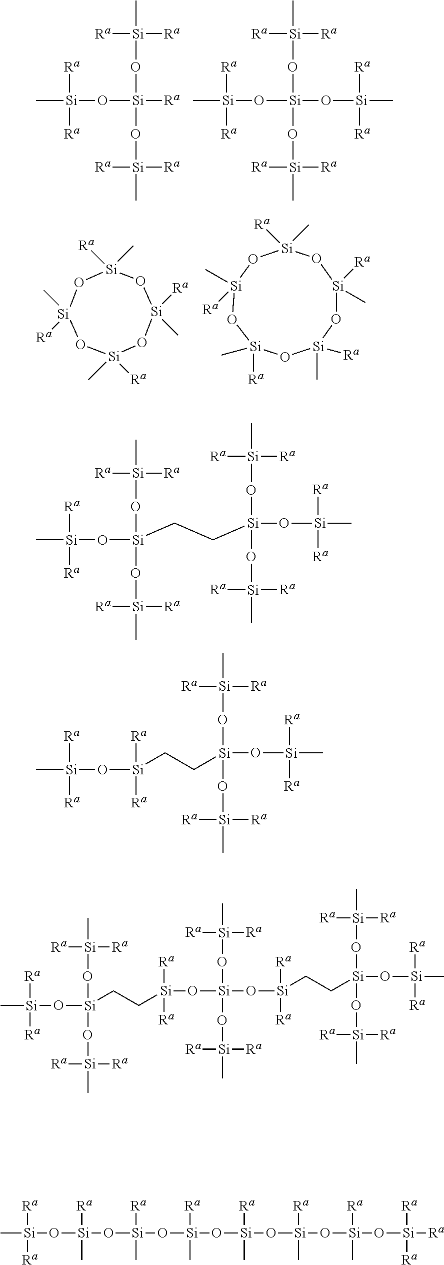

The number of carbon atoms in the alkyl group of R^{e1}, R^{e2}, R^{e3} or R^{e4} is preferably from 1 to 10, more preferably from 1 to 6, further preferably from 1 to 3, particularly preferably from 1 to 2, from such a viewpoint that compound 3-11, compound 3-21 and compound 3-31 can easily be produced.

The number of carbon atoms in the alkyl group portion of the acyloxy group of R^{e2} is preferably from 1 to 10, more preferably from 1 to 6, further preferably from 1 to 3, particularly preferably from 1 to 2, from such a viewpoint that compound 3-11, compound 3-21 and compound 3-31 can easily be produced.

h1 is preferably from 1 to 6, more preferably from 1 to 4, further preferably 1 or 2, particularly preferably 1, from such a viewpoint that compound 3-11, compound 3-21 and compound 3-31 can easily be produced, and the abrasion resistance and fingerprint stain removability of the surface layer will be better.

h2 is preferably from 2 to 6, more preferably from 2 to 4, particularly preferably 2 or 3, from such a viewpoint that compound 3-11, compound 3-21 and compound 3-31 can easily be produced, and the abrasion resistance and fingerprint stain removability of the surface layer will be better.

As other forms of Y¹¹, groups g3-1 (where d1+d3=1 (i.e. d1 or d3 is 0), g1=d2×r1+d4×r1), group g3-2 (where 1=1, and g1=e2×r1), group g3-3 (where g1=2×r1), group g3-4 (where h1=1, and g1=h2×r1), group g3-5 (where i1=1, and g1=i2×r1), group g3-6 (where g1=r1), group g3-7 (where g1=r1×(i3+1)), group g3-8 (where g1=r1×i4), and group g3-9 (where g1=r1×i5) may be mentioned.

As other forms of Y²¹, group g3-1 (where j2=d1+d3, d1+d3≥2, g2=d2×r1+d4×r1), group g3-2 (where j2=e1, e1=2, g2=e2×r1, e2=2), group g3-4 (where j2=h1, h1≥2, g2=h2×r1), and group g3-5 (where j2=i1, i1 is 2 or 3, g2=i2×r1 , i1+i2 is 3 or 4) may be mentioned.

As other forms of Y³¹ and Y³², group g3-1 (where g3=d2×r1+d4×r1, k3=d2×r1+d4×r1), group g3-2 (where g3=e2×r1, and k3=e2×r1), group g3-3 (where g3=2×r1, k3=2×r1), group g3-4 (where g3=h2×r1, and k3=h2×r1), group g3-5 (where g3=i2×r1, and k3=i2×r1), group g3-6 (where g3=r1, and k3=r1), group g3-7 (where g3=r1×(i3+1), k3=r1×(i3+1)), group g3-8 (where g3=r1×i4, and k3=r1×i4), and group g3-9 (where g3=r1×i5, and k3=r1×i5) may be mentioned.

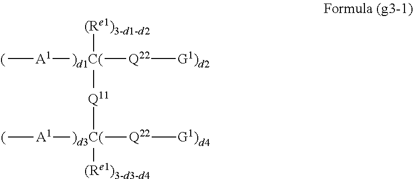

(-A¹-)ₑ₁C(R^{e2})₄₋ₑ₁₋ₑ₂(-Q²²-G¹)ₑ₂ Formula (g3-2)

-A¹-N(-Q²³-G¹)₂ Formula (g3-3)

(-A¹-)ₕ₁Z¹(-Q²⁴-G¹)ₕ₂ Formula (g3-4)

(-A¹-)ᵢ₁Si(R^{e3})₄₋ᵢ₁₋ᵢ₂)-Q²⁵-G¹)ᵢ₂ Formula (g3-5)

-A¹-Q²⁶-G¹ Formula (g3-6)

-A¹-CH(-Q²²-G¹)-Si(R^{e3})₃₋ᵢ₃(-Q²⁵-G¹)ᵢ₃ Formula (g3-7)

-A¹-[CH₂C(R^{e4})(-Q²⁷-G¹)]ᵢ₄-R^{e5} Formula (g3-8)

-A¹-Z^{a}(-Q²⁸-G¹)ᵢ₅ Formula (g3-9)

Here, in the formula (g3-1) to the formula (g3-9), A¹ is bonded to the (OX)ₘ side and G¹ is bonded to the [—Si(R)ₙL₃₋ₙ] side.

G¹ is group g3, and in a case where in each formula, at least two G¹ are present, such at least two G¹ may be the same or different. Symbols other than G¹ are the same as the symbols in the formula (g2-1) to the formula (g2-9).

—Si(R⁸)₃₋ᵣ₁(-Q³-)ᵣ₁ Formula (g3)

Here, in the formula (g3), Si is bonded to the Q²², Q²³, Q²⁴, Q²⁵, Q²⁶, Q²⁷ and Q²⁸ sides, and Q³ is bonded to the [—Si(R)ₙL₃₋ₙ] side. R⁸ is an alkyl group. Q³ is an alkylene group, a group having —C(O)NR⁶—, —C(O)—, —NR⁶— or —O— between carbon-carbon atoms in an alkylene group with at least two carbon atoms, or —(OSi(R⁹)₂)ₚ—O—, and at least two Q³ may be the same or different. r1 is 2 or 3. R⁶ is a hydrogen atom, a C₁₋₆ alkyl group or a phenyl group. R⁹ is an alkyl group, a phenyl group or an alkoxy group, and two R⁹ may be the same or different. p is an integer of from 0 to 5, and in a case where p is at least 2, such at least 2 (OSi(R⁹)₂) may be the same or different.

The number of carbon atoms in the alkylene group as Q³ is preferably from 1 to 10, more preferably from 1 to 6, particularly preferably from 1 to 4, from such a viewpoint that compound 3-11, compound 3-21 and compound 3-31 can easily be produced, as well as the abrasion resistance, light resistance and chemical resistance of the surface layer will be better. However, the lower limit value of the number of carbon atoms in the alkylene group in the case of having a specific bond between carbon-carbon atoms is 2.

The number of carbon atoms in the alkyl group as R⁸ is preferably from 1 to 10, more preferably from 1 to 6, further preferably from 1 to 3, particularly preferably from 1 to 2, from such a viewpoint that compound 3-11, compound 3-21 and compound 3-31 can easily be produced.

The number of carbon atoms in the alkyl group as R⁹ is preferably from 1 to 10, more preferably from 1 to 6, further preferably from 1 to 3, particularly preferably from 1 to 2, from such a viewpoint that compound 3-11, compound 3-21 and compound 3-31 can easily be produced.

The number of carbon atoms in the alkoxy group as R⁹ is preferably from 1 to 10, more preferably from 1 to 6, further preferably from 1 to 3, particularly preferably from 1 to 2, from such a viewpoint that the storage stability of compound 3-11, compound 3-21 and compound 3-31 will be excellent.

p is preferably 0 or 1.

As compound 3-11, compound 3-21 and compound 3-31, for example, compounds of the following formulas are preferred. The compounds of the following formulas are preferred from such a viewpoint that they can industrially easily be produced and handled, and they are superior in the water and oil repellency, abrasion resistance, fingerprint stain removability, lubricity, chemical resistance, light resistance and chemical resistance of the surface layer, and are particularly excellent in the light resistance among them.

R^{f} in the compounds of the following formulas is R^{f1}—(OX)ₘ—O—(CF₂)ₙ— or R^{f2}—(OX)ₘ—O—(CF₂)ₙ—. Here, the definitions of R^{f1}, R^{f2}, X and m are as described above, and n is an integer of from 0 to 6.

Q^{f} in the compounds of the following formulas is —(OX)ₘ—O—(CF₂)ₙ—. Here, X and m are as described above, and n is an integer of from 0 to 6.

As compound 3-11 where Y¹¹ is group g2-1, for example, a compound of the following formula may be mentioned.

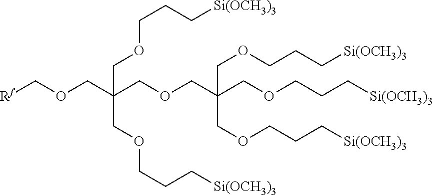

As compound 3-11 where Y¹¹ is group g2-2, for example, compounds of the following formulas may be mentioned.

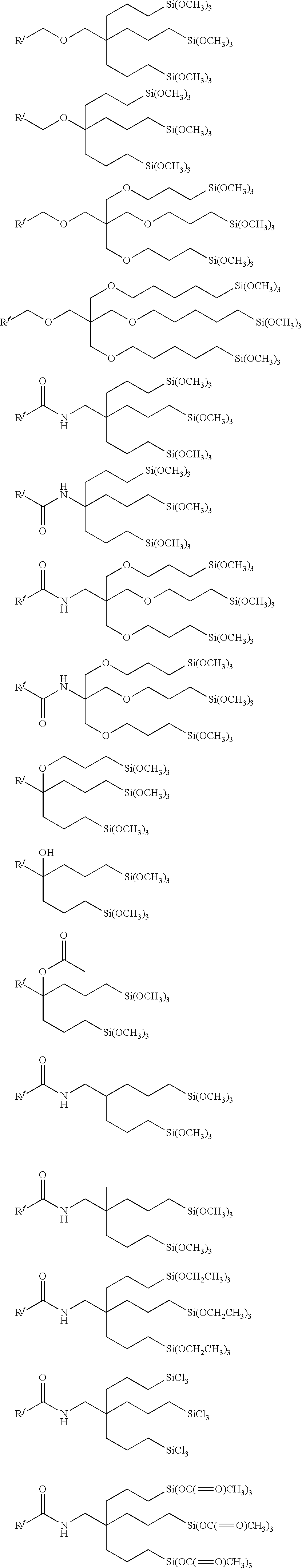

As compound 3-21 where Y²¹ is group g2-2, for example, compounds of the following formulas may be mentioned.

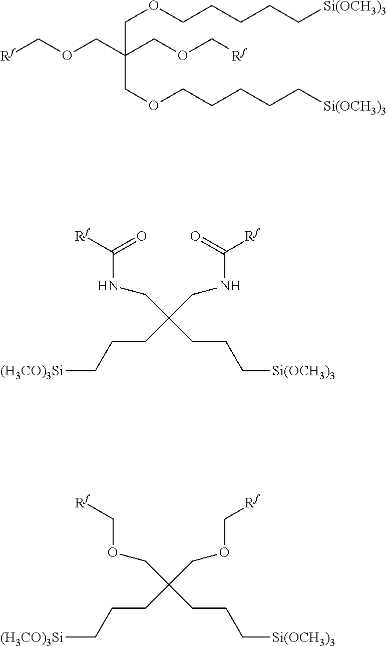

As compound 3-11 where Y¹¹ is group g2-3, for example, compounds of the following formulas may be mentioned.

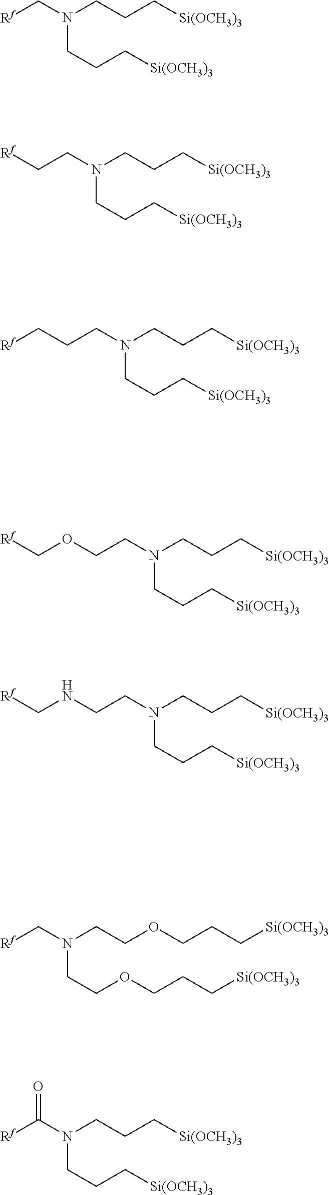

As compound 3-11 where Y¹¹ is group g2-4, for example, compounds of the following formulas may be mentioned.

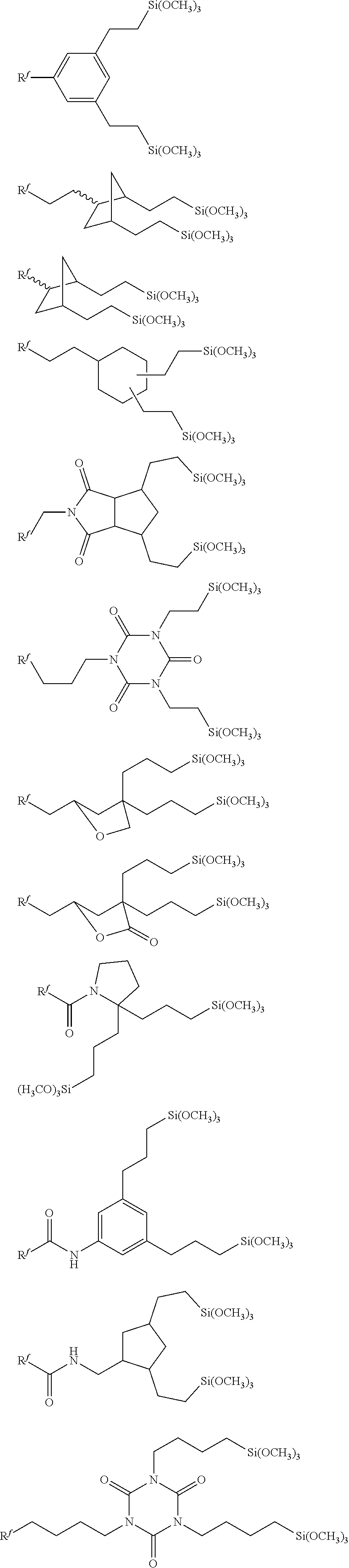

As compound 3-11 where Y¹¹ is group g2-5, for example, compounds of the following formulas may be mentioned.

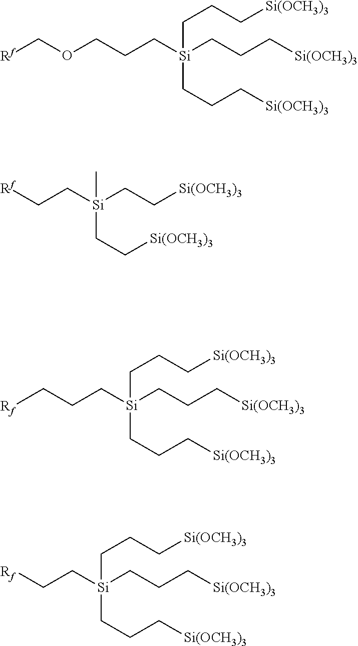

As compound 3-11 where Y¹¹ is group g2-6, for example, compounds of the following formulas may be mentioned.

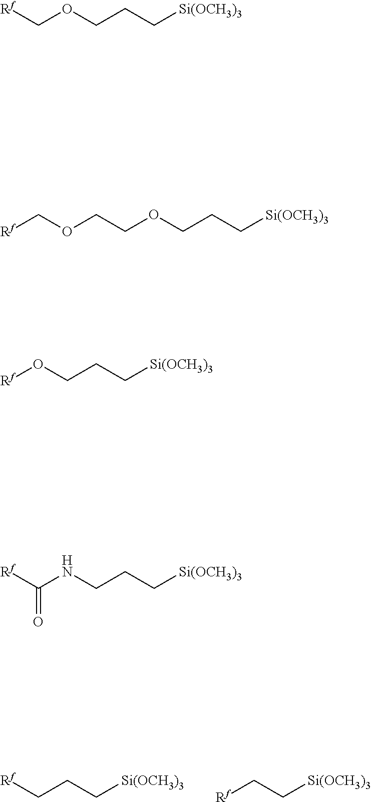

As compounds 3-11 where Y¹¹ is group g2-7, for example, compounds of the following formulas may be mentioned.

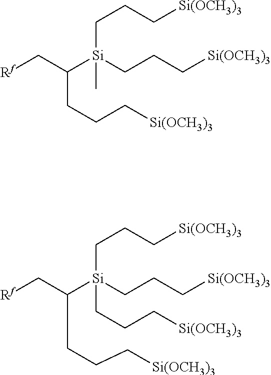

As compound 3-11 where Y¹¹ is group g3-1, for example, compounds of the following formulas may be mentioned.

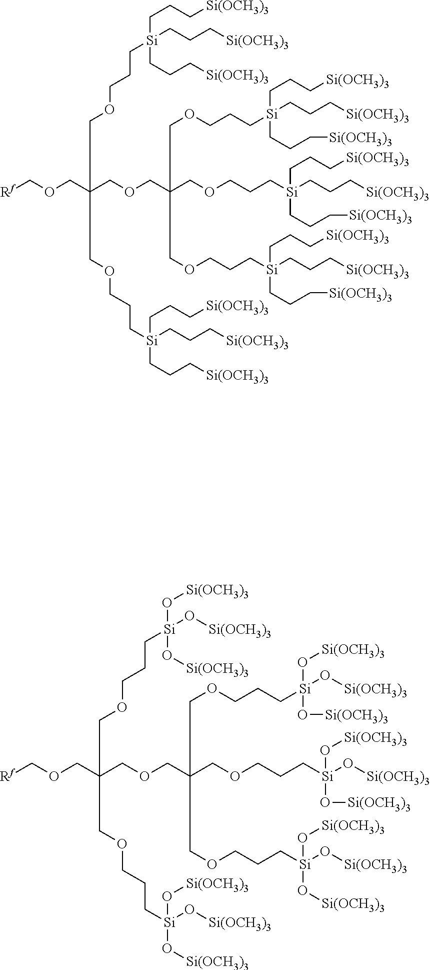

As compound 3-11 where Y¹¹ is group g3-2, for example, compounds of the following formulas may be mentioned.

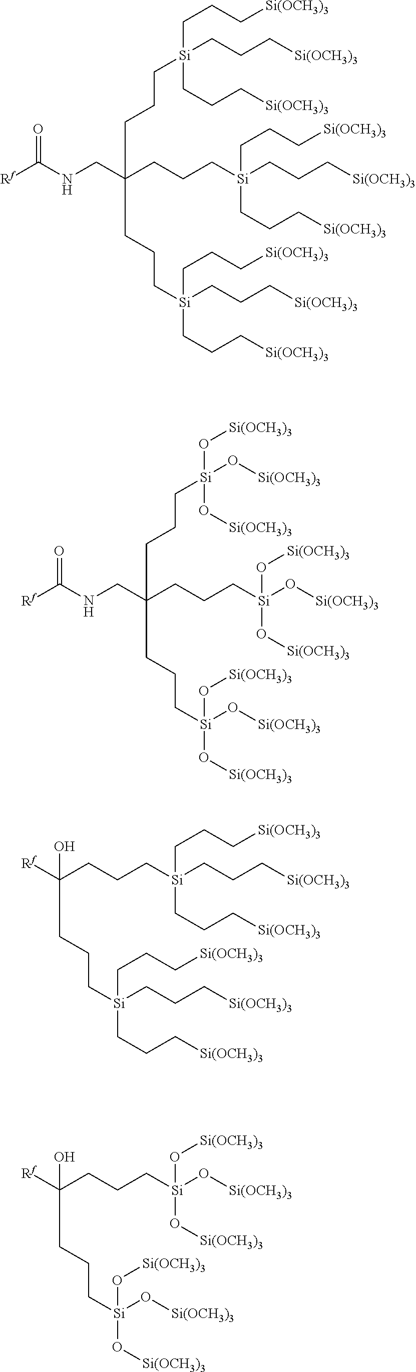

As compound 3-11 where Y¹¹ is group g3-3, for example, compounds of the following formulas may be mentioned.

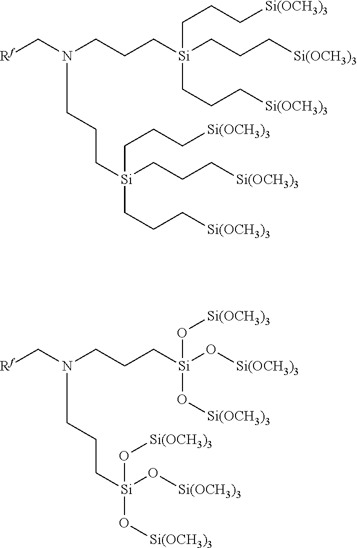

As compounds 3-11 where Y¹¹ is group g3-4, for example, compounds of the following formulas may be mentioned.

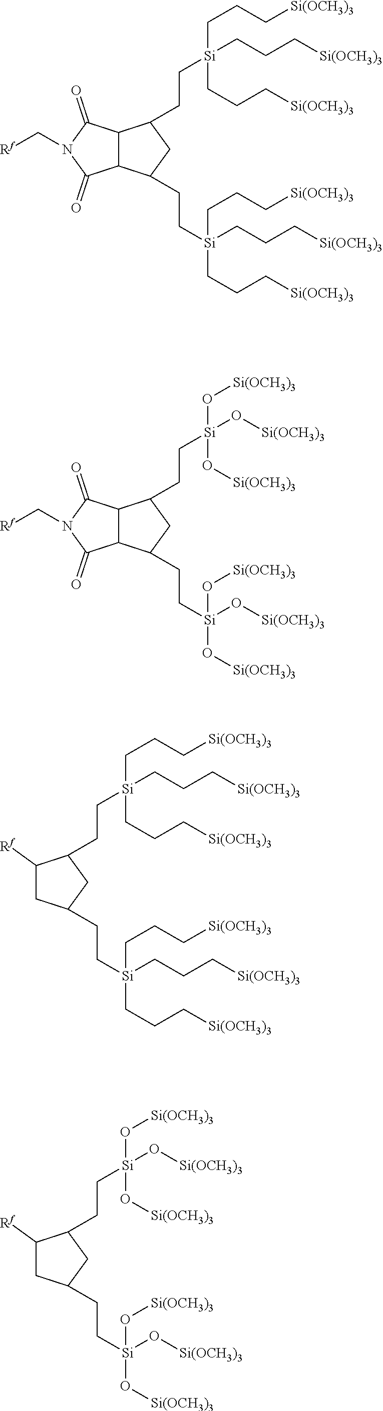

As compound 3-11 where Y¹¹ is group g3-5, for example, compounds of the following formulas may be mentioned.

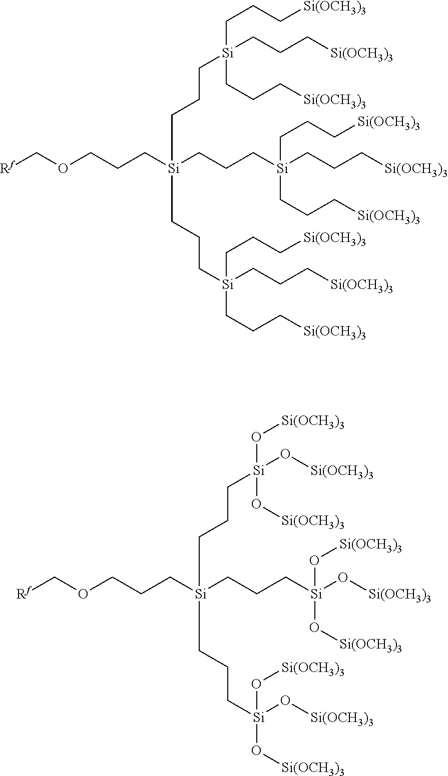

As compound 3-11 where Y¹¹ is group g3-6, for example, compounds of the following formulas may be mentioned.

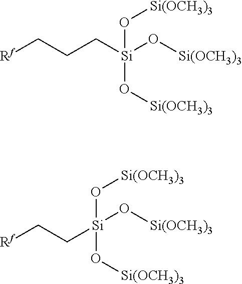

As compound 3-11 where Y¹¹ is group g3-7, for example, compounds of the following formulas may be mentioned.

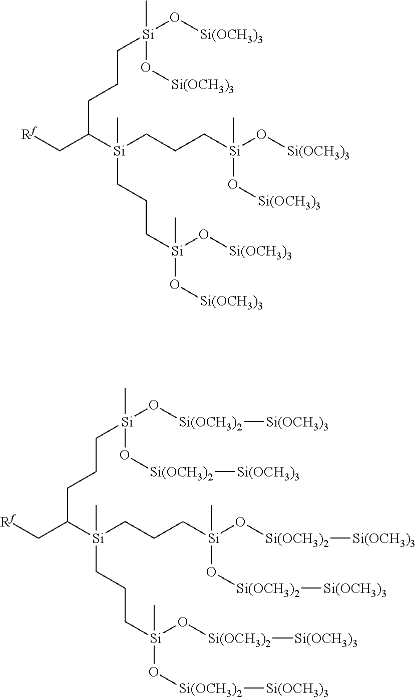

As compound 3-21 where Y²¹ is group g2-1, for example, compounds of the following formulas may be mentioned.

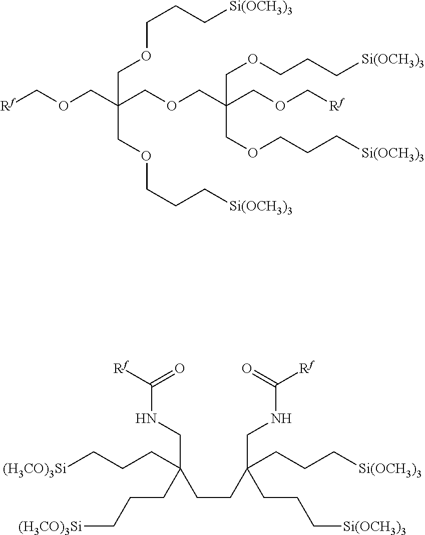

As compound 3-31 where Y³¹ and Y³² are groups g2-1, for example, a compound of the following formula may be mentioned.

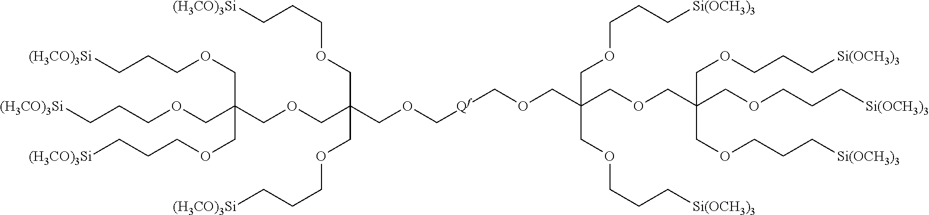

As compound 3-31 where Y³¹ and Y³² are groups g2-2, for example, compounds of the following formulas may be mentioned.

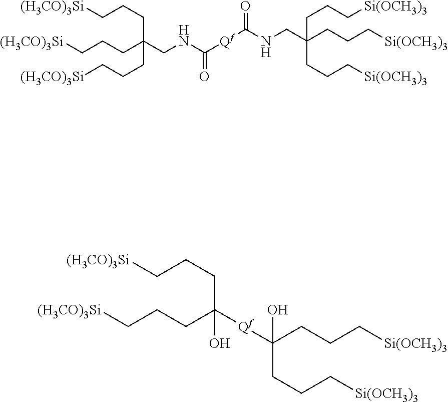

As compound 3-31 where Y³¹ and Y³² are groups g2-3, for example, a compound of the following formula may be mentioned.

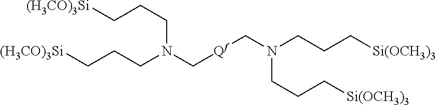

As compound 3-31 where Y³¹ and Y³² are groups g2-4, for example, a compound of the following formula may be mentioned.

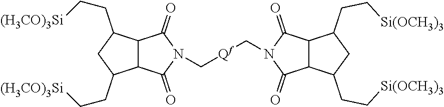

As compound 3-31 where Y³¹ and Y³² are groups g2-5, for example, a compound of the following formula may be mentioned.

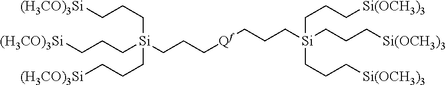

As compound 3-31 where Y³¹ and Y³² are groups g2-6, for example, a compound of the following formula may be mentioned.

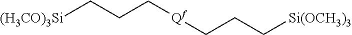

As compound 3-31 where Y³¹ and Y³² are groups g2-7, for example, a compound of the following formula may be mentioned.

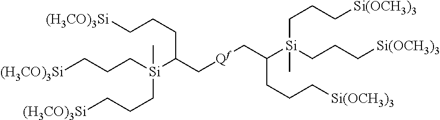

As compound 3-31 where Y³¹ and Y³² are groups g3-2, for example, compounds of the following formulas may be mentioned.

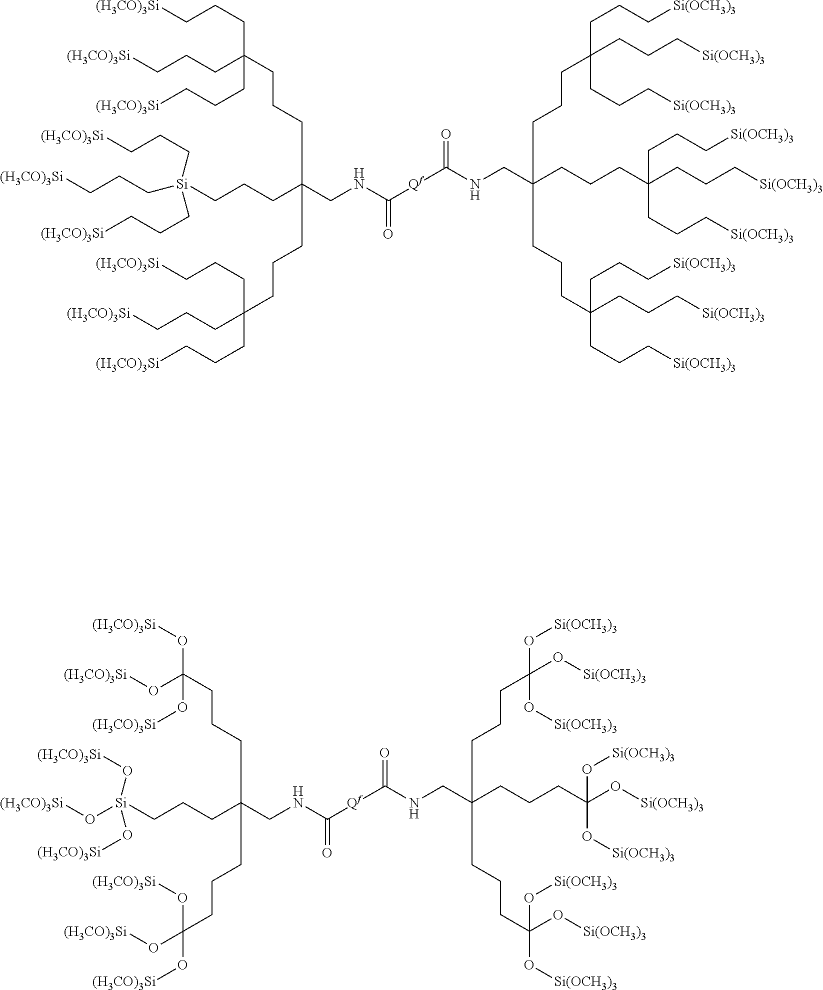

As specific examples of the specific fluorinated ether compound, for example, those disclosed in the following documents may be mentioned.

Perfluorinated polyether-modified am inosilanes as described in JP-A-11-029585 and JP-A-2000-327772,

Silicon-containing organic fluorinated polymers as described in Japanese Patent No. 2874715,

Organosilicon compounds as described in JP-A-2000-144097,

Fluorinated siloxanes as described in JP-A-2002-506887,

Organosilicone compounds as described in JP-A-2008-534696,

Fluorinated modified hydrogen-containing polymers as described in Japanese Patent No. 4138936,

Compounds as described in U.S. Patent Application Publication No. 2010/0129672, WO2014/126064 and JP-A-2014-070163,

Organosilicon compounds as described in WO2011/060047 and WO2011/059430,

Fluorinated organosilane compounds as described in WO2012/064649,

Polymers containing fluorooxyalkylene groups as described in JP-A-2012-72272,

Fluorinated ether compounds as described in WO2013/042732, WO2013/121984, WO2013/121985, WO2013/121986, WO2014/163004, JP-A-2014-080473, WO2015/087902, WO2017/038830, WO2017/038832, WO2017/187775, WO2018/216630, WO2019/039186, WO2019/039226, WO2019/039341, WO2019/044479, WO2019/049753, WO2019/163282 and JP-A-2019-044158,

Perfluoro(poly)ether-containing silane compounds as described in JP-A-2014-218639, WO2017/022437, WO2018/079743, WO2018/143433,

Perfluoro(poly)ether group-containing silane compounds as described in WO2018/169002,

Fluoro(poly)ether group-containing silane compounds as described in WO2019/151442,

(Poly)ether group-containing silane compounds as described in WO2019/151445,

Perfluorinated polyether group-containing compounds as described in WO2019/098230,

Fluoropolyether group-containing polymer modified silanes as described in JP-A-2015-199906, JP-A-2016-204656, JP-A-2016-210854 and JP-A-2016-222859,

Fluorinated compounds as described in WO2019/039083 and WO2019/049754.

As commercially available products of the specific fluorinated ether compound, the KY-100 series (KY-178, KY-185, KY-195, etc.) manufactured by Shin-Etsu Chemical Co., Ltd., Afluid (registered trademark) S550 manufactured by AGC Inc., Optool (registered trademark) DSX, Optool (registered trademark) AES, Optool (registered trademark) UF_{503,} Optool (registered trademark) UD509, etc. manufactured by DAIKIN INDUSTRIES, LTD. may be mentioned.

As the specific fluorinated ether compound, one type may be used alone, or two or more types may be used in combination.

### Crosslinking Agent

The crosslinking agent to be contained in the composition of the present invention is a crosslinking agent having a plurality of reactive silyl groups and no poly(oxyfluoroalkylene) chains. Specific examples of the reactive silyl groups and the poly(oxyfluoroalkylene) chains in the crosslinking agent are the same as the reactive silyl groups and poly(oxyfluoroalkylene) chains in the specific fluorinated ether compound as described above.

The number of reactive silyl groups in the crosslinking agent is at least 2, and from such a viewpoint that the abrasion resistance and the water and oil repellency of the surface layer will be better, preferably from 2 to 8, more preferably from 2 to 6, particularly preferably from 3 to 6.

The crosslinking agent is preferably compound A, from such a viewpoint that the abrasion resistance and the water and oil repellency of the surface layer will be better. Compound A is a compound represented by the formula (A).

R^{a1}-L^{a1}-C(—Y^{a1}-T^{a1})ₘ₁(—R^{a2})₃₋ₘ₁ Formula (A)

R^{a1} is a hydrogen atom, a halogen atom, an amino group, a hydroxy group, a reactive silyl group, -L^{a2}-C(—Y^{a2}-T^{a2})ₘ₂(—R^{a3})₃₋ₘ₂, R^{a4}C(O)NH—, R^{a4}S(O)₂O—, R^{a4}C(O)O— or a thiol group, and from such a viewpoint that the abrasion resistance and the water and oil repellency of the surface layer will be better, -L^{a2}-C(—Y^{a2}-T^{a2})ₘ₂(—R^{a3})₃₋ₘ₂ is preferred.

As specific examples of the halogen atom in R^{a1}, a fluorine atom, a chlorine atom, a bromine and an iodine atom may be mentioned, and a chlorine atom, a bromine atom or an iodine atom is preferred.

Specific examples of the reactive silyl group in Rai are the same as the reactive silyl groups in the above-described specific fluorinated ether compound.

L^{a1} and L^{a2} are each independently a C₁₋₁₀ alkylene group which may have a fluorine atom, and from such a viewpoint that the abrasion resistance and the water and oil repellency of the surface layer will be better, a C₁₋₁₀ alkylene group having no fluorine atom is preferred.

The number of carbon atoms in the alkylene group is preferably from 1 to 8, particularly preferably from 2 to 8, from such a viewpoint that the abrasion resistance and the water and oil repellency of the surface layer will be better.

The alkylene group may be linear, branched or cyclic.

Y^{a1} and Y^{a2} are each independently a fluorine atom or a C₂₋₁₀ alkylene group which may have an etheric oxygen atom between carbon-carbon atoms, and from such a viewpoint that the abrasion resistance and the water and oil repellency of the surface layer will be better, a fluorine atom and a C₂₋₁₀ alkylene group which does not have an etheric oxygen atom are preferred.

The number of carbon atoms in the alkylene group is preferably from 2 to 8, particularly preferably from 2 to 6, from such a viewpoint that the abrasion resistance and the water and oil repellency of the surface layer will be better.

The alkylene group may be linear, branched or cyclic.

T^{a1} and T^{a2} are each independently a reactive silyl group.

Specific examples of the reactive silyl group in T^{a1} and T^{a2} are the same as the reactive silyl groups in the above-described specific fluorinated ether compound.

R^{a2} and R^{a3} are each independently a C₁₋₁₀ alkyl group which may have a fluorine atom, or a hydrogen atom, and a C₁₋₁₀ alkyl group having no fluorine atom, or a hydrogen atom, is preferred.

The number of carbon atoms in the alkyl group is preferably from 2 to 8, particularly preferably from 2 to 6, from such a viewpoint that the abrasion resistance and the water and oil repellency of the surface layer will be better.

The alkyl group may be linear, branched or cyclic.

R^{a4} are each independently a C₁₋₅ alkyl group which may have a fluorine atom.

The number of carbon atoms in the alkyl group is preferably from 1 to 3, particularly preferably 1, from such a viewpoint that the abrasion resistance and the water and oil repellency of the surface layer will be better.

m1 and m2 are each independently an integer of from 1 to 3, and from such a viewpoint that the abrasion resistance and the water and oil repellency of the surface layer will be better, preferably 2 or 3, particularly preferably 3.

However, in a case where m1 is 1, R^{a1} is a reactive silyl group or -L^{a2}-C(—Y^{a2}-T^{a2})ₘ₂(—R^{a3})₃₋ₘ₂.

In a case where m1 is at least 2, the multiple —Y^{a1}-T^{a1} may be the same or different. In a case where m2 is at least 2, the multiple —Y^{a2}-T^{a2} may be the same or different.

In a case where m1 is 1, the multiple R^{a2} may be the same or different. In a case where m2 is 1, the multiple R^{a3} may be the same or different.

In particular, if R^{a1} is -L^{a2}-C(—Y^{a2}-T^{a2})ₘ₂(—R^{a3})₃₋ₘ₂ and m1 and m2 are both 3, the abrasion resistance and the water and oil repellency of the surface layer will be better.

In the formula (A), it is preferred that L^{a1} is a C₁₋₁₀ alkylene group having no fluorine atom, Y^{a1} is a C₂₋₁₀ alkylene group having no fluorine atom and no etheric oxygen atom, and R^{a2} is a C₁₋₁₀ alkyl group having no fluorine atom, or a hydrogen atom (hereinafter referred to also as “embodiment A”). The initial water repellency and the abrasion resistance of the surface layer will thereby be better.

In formula (A), in a case where R^{a1} is -L^{a2}-C(—Y^{a2}-T^{a2})ₘ₂(—R^{a3})₃₋ₘ₂, it is preferred that L^{a2} is a C₁₋₁₀ alkylene group having no fluorine atom, Y^{a2} is a C₂₋₁₀ alkylene group having no fluorine atom and no etheric oxygen atom, and R^{a3} is a C₁₋₁₀ alkyl group having no fluorine atom, or a hydrogen atom (hereinafter referred to also as “embodiment B”). The initial water repellency and the abrasion resistance of the surface layer will thereby be better.

In particular, in the formula (A), in a case where R^{a1} is -L^{a2}- C(—Y^{a2}-T^{a2})ₘ₂(—R^{a3})₃₋ₘ₂, if both embodiment A and embodiment B are satisfied, the initial water repellency and the abrasion resistance of the surface layer will be better.

As the crosslinking agent, one type may be used alone, or two or more types may be used in combination.

Specific examples of the crosslinking agent will be shown below.
CH₃—C[CH₂—CH₂—CH₂—Si(OCH₃)₃]₃
Cl—CH₂—C[CH₂—CH₂—CH₂—Si(OCH₃)₃]₃
HO—CH₂—C[CH₂—CH₂—CH₂—Si(OCH₃)₃]₃
[Si(OCH₃)₃—CH₂—CH₂—CH₂]₃C—CH₂—CH₂—C[CH₂—CH₂—CH₂—Si(OCH₃)₃]₃
CH₂—CH₂—CH₂—CH₂—C[CH₂—CH₂—CH₂—Si(OCH₃)₃]₃
[Si(OCH₃)₃—CH₂—CH₂—CH₂]₃C—CH₂—CH₂—CH₂—CH₂—CH₂—CH₂—CH₂—CH₂—C[CH₂—CH₂—CH₂—Si(OCH₃)₃]₃
Si(OCH₃)₃—CH₂—CH₂—CH₂—CH₂—C[CH₂—CH₂—CH₂—Si(OCH₃)₃]₃
CH₃—CH[CH₂—CH₂—CH₂—Si(OCH₃)₃]₂
[Si(OCH₃)₃—CH₂—CH₂—CH₂]₂CH—CH₂—CH₂—CH[CH₂—CH₂—CH₂—Si(OCH₃)₃]₂
Si(OCH₃)₃—CH₂—CH[CH₂—CH₂—CH₂—Si(OCH₃)₃]₂
NH₂—CH₂—C[CH₂—CH₂—CH₂—Si(OCH₃)₃]₃
OH—CH₂—C[CH₂—O—CH₂—CH₂—CH₂—Si(OCH₃)₃]₃
Cl—CH₂—C[CH₂—O—CH₂—CH₂—CH₂—Si(OCH₃)₃]₃
CH₃—C[CH₂—O—CH₂—CH₂—CH₂—Si(OCH₃)₃]₃
[Si(OCH₃)₃—CH₂—CH₂—CH₂—O—CH₂]₃C—CH₂—CH₂—C[CH₂—O—CH₂—CH₂—CH₂—Si(OCH₃)₃]₃
CH₃—C[CH₂—CH₂—CH₂—Si(OCH₂CH₃)₃]₃
CF₃—S(O)₂O—CH₂—C[CH₂—CH₂—CH₂—Si(OCH₃)₃]₃
HS—CH₂—C[CH₂—CH₂—CH₂—Si(OCH₃)₃]₃
CH₃—C(O)NH—CH₂—C[CH₂—CH₂—CH₂—Si(OCH₃)₃]₃
CH₃—C(O)O—CH₂—C[CH₂—CH₂—CH₂—Si(OCH₃)₃]₃

The method for producing the crosslinking agent is not particularly limited, and, for example, it can be produced by the method described in the section of Examples given later.

### Liquid Medium

The composition of the present invention may be a composition to be used in a dry coating method or a composition to be used in a wet coating method.

In a case where the composition of the present invention is a composition to be used in a wet coating method, the composition of the present invention preferably contains a liquid medium.

As specific examples of the liquid medium, water and an organic solvent may be mentioned.

The liquid medium preferably contains an organic solvent, and more preferably contains an organic solvent with a boiling point of from 35 to 250° C. from the viewpoint of excellent coating properties. Here, the boiling point means the standard boiling point.

As specific examples of the organic solvent, a fluorinated organic solvent and a non-fluorinated organic solvent may be mentioned, and a fluorinated organic solvent is preferred from the viewpoint of its superior solubility. As the organic solvent, one type may be used alone, or two or more types may be used in combination.

As specific examples of the fluorinated organic solvent, a fluorinated alkane, a fluorinated aromatic compound, a fluoroalkyl ether, a fluorinated alkyl amine and a fluoroalcohol may be mentioned.

The fluorinated alkane is preferably a compound with from 4 to 8 carbon atoms, and, for example, C₆F₁₃H (AC-2000: product name, manufactured by AGC Inc.), C₆F₁₃C₂H₅ (AC-6000: product name, manufactured by AGC Inc.), and C₂F₅CHFCHFCF₃ (Vertrel: product name, manufactured by DuPont) may be mentioned.

As specific examples of the fluorinated aromatic compound, hexafluorobenzene, trifluoromethylbenzene, perfluorotoluene, 1,3-bis(trifluoromethyl)benzene and 1,4-bis(trifluoromethyl)benzene may be mentioned.

The fluoroalkyl ether is preferably a compound with from 4 to 12 carbon atoms, and, for example, CF₃CH₂OCF₂CF₂H (AE-3000: product name, manufactured by AGC Inc.), C₄F₉OCH₃ (Novec-7100: product name, manufactured by 3M), C₄F₉OC₂H₅ (Novec-7200: product name, manufactured by 3M), and C₂F₅CF(OCH₃)C₃F₇ (Novec-7300: product name, manufactured by 3M) may be mentioned.

As specific examples of the fluorinated alkyl amine, perfluorotripropylamine and perfluorotributylamine may be mentioned.

As specific examples of the fluoroalcohol, 2,2,3,3-tetrafluoropropanol, 2,2,2-trifluoroethanol and hexafluoroisopropanol may be mentioned.

As the non-fluorinated organic solvent, a compound consisting only of hydrogen atoms and carbon atoms, and a compound consisting only of hydrogen atoms, carbon atoms and oxygen atoms, are preferred, and, specifically, a hydrocarbon organic solvent, a ketone organic solvent, an ether organic solvent, an ester organic solvent and an alcohol organic solvent may be mentioned.

As specific examples of the hydrocarbon organic solvent, hexane, heptane and cyclohexane may be mentioned.

As specific examples of the ketone organic solvent, acetone, methyl ethyl ketone and methyl isobutyl ketone may be mentioned.

As specific examples of the ether organic solvent, diethyl ether, tetrahydrofuran and tetraethylene glycol dimethyl ether may be mentioned.

As specific examples of the ester organic solvent, ethyl acetate and butyl acetate may be mentioned.

As specific examples of the alcohol organic solvent, isopropyl alcohol, ethanol and n-butanol may be mentioned.

### Other Components

The composition of the present invention may contain components other than those mentioned above.

As other components, for example, unavoidable compounds in production, such as by-products formed in the manufacturing process of the specific fluorinated ether compound or the crosslinking agent, unreacted raw materials, etc., may be mentioned.

As specific examples of such other components, the following compound X and the following compound Y may be mentioned.

R^{fa}—(OX^{a})ₘ₁-L^{a}-CZ^{a1}═CH₂ Formula (X)

CH₂═CZ^{b2}-L^{b2}-(OX^{b})ₘ₂-L^{b1}-CZ^{b1}═CH₂ Formula (Y)

In the formula (X), R^{fa} is a C₁₋₂₀ fluoroalkyl group, X^{a} is a C₁₋₆ fluoroalkylene group, L^{a} is a single bond or a divalent linking group (but excluding (OX^{a})ₙₐ, where na is an integer of at least 1), Z^{a1} is a fluorine atom or a trifluoromethyl group, and m1 is an integer of at least 2.

In the formula (Y), X^{b} is a C₁₋₆ fluoroalkylene group, L^{b1} and L^{b2} are each independently a single bond or a divalent linking group (but excluding (OX^{b})_{nb}, where nb is an integer of at least 1), Z^{b1} and Z^{b2} are each independently a fluorine atom or a trifluoromethyl group, and m2 is an integer of at least 2.

### Contents

The content of the specific fluorinated ether compound is preferably from 30 to 99.99 mass %, more preferably from 40 to 99.99 mass %, particularly preferably from 50 to 99.95 mass %, to the entire solid content mass of the composition of the present invention, from such a viewpoint that the initial water repellency and the abrasion resistance of the surface layer will be better.

The content of the crosslinking agent is preferably from 0.001 to 10 mass %, more preferably from 0.01 to 5 mass %, particularly preferably from 0.05 to 1 mass %, to the entire solid content mass of the composition of the present invention, from such a viewpoint that the initial water repellency and the abrasion resistance of the surface layer will be better.

In a case where the composition contains a liquid medium, the mass of the solid content of the composition is the mass having the liquid medium removed from the composition.

In the composition, the molar ratio of the content of the crosslinking agent to the content of the specific fluorinated ether compound (amount of the crosslinking agent/amount of the fluorinated ether compound) is preferably from 0.0001 to 0.5000, more preferably from 0.0010 to 0.5000, further preferably from 0.0010 to 0.3000, particularly preferably from 0.0050 to 0.2500. When the molar ratio is within the above range, the abrasion resistance of the surface layer will be more excellent.

In a case where the composition of the present invention contains the above-described liquid medium, the content of the liquid medium is preferably from 70 to 99.99 mass %, particularly preferably from 80 to 99.9 mass %, to the entire mass of the composition of the present invention.

In a case where the composition of the present invention contains the above-described other components, the content of such other components is preferably from 0 to 70 mass %, more preferably from 0 to 60 mass %, particularly preferably from 0 to 50 mass %, to the content of the specific fluorinated ether compound.

### Base Material with Surface Layer

The base material with a surface layer of the present invention has a base material and a surface layer formed from the above-described composition. Since the base material with a surface layer of the present invention has a surface layer formed from the above-described composition, it is excellent in abrasion resistance and also excellent in water and oil repellency.

### Base Material

The base material is not particularly limited so long as it is a base material that may be used in contact with another article (e.g. a stylus) or a human finger, a base material that may be held with human fingers during operation, and/or a base material that may be placed on another article (e.g. a table), and that is required to provide water and oil repellency. As specific examples of the material of the base material, a metal, a resin, glass, sapphire, ceramic, stone, and a composite of these materials may be mentioned. The glass may be chemically strengthened.

As the base material, a base material for touch panels and a base material for display are preferred, and a base material for touch panels is particularly preferred. The base material for touch panels preferably has translucency. The term “having translucency” means that the transmittance of vertically-incident visible light is at least 25% in accordance with JIS R3106:1998 (ISO 9050:1990). As the base material for touch panels, glass and a transparent resin are preferred.

Also preferred as the base material are glass or a resin film to be used in building materials, decorative building materials, interiors, transportation equipment (e.g. automobiles), signs and displays, drinking vessels and tableware, aquariums, ornamental equipment (e.g. frames, boxes), laboratory equipment, furniture, and art, sports, and games, as well as a glass sheet or a resin film to be used in the exterior parts (excluding displays) of equipment such as cell phones (e.g. smart phones), portable information terminals, game consoles, remote controls, etc.

The base material may be a base material having one or both surfaces treated with surface treatment such as corona discharge treatment, plasma treatment, plasma graft polymerization treatment, etc.

The surface layer may be formed directly on the surface of the base material or may be formed on the base material via another film formed on the surface of the base material. As a specific example of such another film, a base film formed on the surface of the base material by priming the base material with a compound described in paragraphs 0089 to 0095 of WO2011/016458, SiO₂, or the like, may be mentioned.

### Surface Layer

The surface layer is a layer to be formed from the above-described composition.

As described above, the surface layer contains a condensed product in which some or all of the reactive silyl groups of the specific fluorinated ether compound have undergone a hydrolysis reaction and dehydration-condensation reaction. Further, the surface layer also contains the above-described crosslinking agent or a component derived from it.

The thickness of the surface layer is preferably from 1 to 100 nm, particularly preferably from 1 to 50 nm. When the thickness of the surface layer is at least the above lower limit value, the effect by the surface layer will be sufficiently obtainable. When the thickness of the surface layer is at most the above upper limit value, the utilization efficiency will be high.

The thickness of the surface layer can be calculated from the vibration period of an interference pattern of reflected X-rays obtained by the X-ray reflectometry (XRR) using an X-ray diffractometer for thin film analysis.

### Method for Producing Base Material with Surface Layer

The method for producing a base material with a surface layer is a method of forming a surface layer on a base material by a dry coating method or a wet coating method by using the above-described composition.

The base material with a surface layer of the present invention can be produced, for example, by the following methods.
A method of obtaining a base material with a surface layer formed on the surface of the base material by treating the surface of the base material by a dry coating method using the above-described composition containing no liquid medium (hereinafter referred to also as the “composition for dry coating”).
A method of obtaining a base material with a surface layer formed on the surface of the base material by applying the above-described composition containing a liquid medium by a wet coating method (hereinafter referred to also as the “composition for wet coating”) to the surface of the base material, followed by drying.

As specific examples of the dry coating method, a vacuum vapor deposition method, a CVD method and a sputtering method may be mentioned. Among them, the vacuum vapor deposition method is suitable from the viewpoints of suppressing decomposition of the specific fluorinated ether compound and simplicity of equipment. At the time of the vacuum vapor deposition, a pellet-like material having the composition for dry coating supported on a porous metal such as iron or steel, or a pellet-like material obtained by impregnating and drying the composition for wet coating, may be used.

As specific examples of the wet coating method, a spin coating method, a wipe coating method, a spray coating method, a squeegee coating method, a dip coating method, a die coating method, an inkjet method, a flow coating method, a roll coating method, a casting method, a Langmuir-Blodgett method and a gravure coating method may be mentioned.

The drying temperature after wet coating the composition is preferably from 20 to 200° C., particularly preferably from 80 to 160° C.

### EXAMPLES

In the following, the present invention will be described in detail with reference to Examples. Ex. 1 to Ex. 21 are Examples of the present invention, and Ex. 22 is Comparative Example. However, the present invention is not limited to these Examples. The amounts of the respective components in Table given later are shown on a mass basis.

### Synthesis Example 1: Synthesis of Fluorinated Ether Compound 3-1

The following compound 3-1 was obtained in accordance with the method described in Synthesis Example 8 of WO2018/143433.

CF₃CF₂CF₂—[OCF(CF₃)CF₂]₂₂—OCF(CF₃)—C(O)NH—CH₂C[CH₂CH₂CH₂—Si(OCH₃)₃]₃ Formula (3-1)

### Synthesis Example 2: Synthesis of Compound A-1

### Synthesis of Compound a-1

### Synthesis of Compound a-1a

DiethylDiallylmalonate (60.0 g, 250 mmol), lithium chloride (23.7 g, 559 mmol), water (6.45 g, 360 mmol) and dimethyl sulfoxide (263 g) were added and stirred at 160° C. After cooling to room temperature, water was added, followed by extraction with ethyl acetate. Hexane was added to the organic layer, followed by washing with brine, and drying with sodium sulfate. After filtration, the solvent was distilled off to obtain 39.5 g of the following compound a-1a.

CH₂═CH—CH₂—CH(C(O)OC₂H₅)—CH₂—CH═CH₂ Formula (a-1a)

NMR spectrum of compound a-1a:

¹H-NMR (400 MHz, Chloroform-d) δ (ppm): (ddt, J=17.1, 10.1, 7.0 Hz, 2H), 5.06-4.94 (m, 4H), 4.09 (q, J=7.1 Hz, 2H), 2.47 (ddd, J=14.0, 8.0, 6.1 Hz, 1H), 2.33 (dt, J=14.9, 7.5 Hz, 2H), 2.22 (dt, J=14.1, 6.5 Hz, 2H), 1.21 (t, J=7.1 Hz, 3H).

### Synthesis of Compound a-1b

After adding THF (260 mL) and diisopropylamine (29.8 mL, 294 mmol), the solution was cooled to −78° C. An n-butyllithium in hexane (2.76 M, 96.6 mL, 294 mmol) was added, and the temperature was raised to 0° C. After stirring, the mixture was cooled to −78° C., whereby a THF solution of lithium diisopropylamide (LDA) was prepared. The above compound a-1a (39.5 g, 235 mmol) was added to the THF solution, followed by stirring, and then, allyl bromide (24.1 mL, 278 mmol) was added. The temperature was raised to 0° C., 1M hydrochloric acid (100 mL) was added, and THF was distilled off under reduced pressure. After extraction with dichloromethane, sodium sulfate was added. After filtration, the solvent was distilled off, followed by flash column chromatography using silica gel to obtain 45.0 g of compound a-1 b.

C₂H₅O(O)C—C(CH₂—CH═CH₂)₃ Formula (a-1b)

NMR spectrum of compound a-1b:

¹H-NMR (400 MHz, Chloroform-d) δ (ppm): 5.74-5.62 (m, 3H), 5.04 (dd, J=13.6, 1.9 Hz, 6H), 4.10 (q, J=7.1 Hz, 2H), 2.29 (d, J=7.4 Hz, 6H), 1.22 (t, J=7.1 Hz, 3H).

### Synthesis of Compound a-1c

The above compound a-1b (45.0 g, 216 mmol) was dissolved in THF (620 mL), followed by cooling to 0° C. A THF solution of lithium aluminum hydride (104 mL, 260 mmol) was added, followed by stirring. Water and a 15% sodium hydroxide aqueous solution were added, followed by stirring at room temperature, and diluting with dichloromethane. After filtration, the solvent was distilled off, followed by flash column chromatography using silica gel to obtain 31.3 g of the following compound a-1c.

HOCH₂—C(CH₂—CH═CH₂)₃ Formula (a-1c)

NMR spectrum of compound a-1c:

¹H-NMR (400 MHz, Chloroform-d) δ (ppm): 5.90-5.76 (m, 3H), 5.10-5.02 (m, 6H), 3.38 (s, 2H), 2.03 (dt, J=7.5, 1.2 Hz, 6H), 1.45 (s, 1H).

### Synthesis of Compound a-1

Acetonitrile (380 mL), the above compound a-1c (31.3 g, 188 mmol), triphenylphosphine (64.3 g, 245 mmol) and carbon tetrachloride (33.9 g, 221 mmol) were added and stirred at 90° C. After concentration, ethyl acetate/hexane was added, followed by stirring. After filtration and concentration, by distillation (70° C., 3 hPa), the following compound a-1 was obtained in an amount of 28.2 g.

ClCH₂—C(CH₂—CH═CH₂)₃ Formula (a-1)

NMR spectrum of compound a-1:

¹H-NMR (400 MHz, Chloroform-d) δ (ppm): 5.83-5.67 (m, 3H), 5.16-5.01 (m, 6H), 3.32 (s, 2H), 2.05 (dt, J=7.5, 1.1 Hz, 6H).

### Synthesis of Compound a-2

Under a nitrogen atmosphere, to Zn Powder (0.98 g), nickel chloride (1.30 g) and compound a-1 (1 g), deionized water (1 mL) and hexamethylphosphoric triamide (HMPA) (15 mL) were added, and in MW (microwave) (53 W, 41 kHz), heating and stirring were conducted at 60° C. The obtained mixture was column purified with silica gel (40 g) (eluent hexane) to obtain compound a-2 (500 mg).

CH₃—C(CH₂—CH═CH₂)₃ Formula (a-2)

NMR spectrum of compound a-2:

¹H-NMR (400 MHz, Chloroform-d) δ (ppm): 5.87-5.77 (m, 3H), 5.06-5.00 (m, 6H), 1.98 (d, J=7.8 Hz, 6H), 0.86 (s, 3H).

### Synthesis of Compound A-1

To the above compound a-2 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-1.

CH₃—C[CH₂—CH₂—CH₂—Si(OCH₃)₃]₃ Formula (A-1)

### Synthesis Example 3: Synthesis of Compound A-2

To the above compound a-1 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-2.

Cl—CH₂—C[CH₂—CH₂—CH₂—Si(OCH₃)₃]₃ Formula (A-2)

### Synthesis Example 4: Synthesis of Compound A-3

To the above compound a-1c (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-3.

HO—CH₂—C[CH₂—CH₂—CH₂—Si(OCH₃)₃]₃ Formula (A-3)

### Synthesis Example 5: Synthesis of Compound A-4

### Synthesis of Compound a-4

### Synthesis of Compound a-4a

Under nitrogen atmosphere, manganese bromide (11 mg) and bis(pinacolato)diboron (B₂pin₂) (1.6 g) were added. Then, dimethyl ether (DME) (5 mL) and tetramethylethylenediamine (TMEDA) (4% (v/v) solution in DME) (0.1 mL) were added.

Next, 2.2 mL of ethylmagnesium bromide (EtMgBr, 3M solution in Et₂O) was dropwise added, and then, compound a-1 (1 g) was added. After stirring at room temperature for 4 hours, a 1M hydrochloric acid solution (20 mL) was added, and after extraction with diethyl ether (Et₂O) (120 mL), the organic layer was dehydrated with magnesium sulfate, filtered and concentrated.

The obtained mixture was purified by silica gel column chromatography to obtain compound a-4a (800 mg).

BpinCH₂—C(CH₂—CH═CH₂)₃ Formula (a-4a)

### Synthesis of Compound a-4b

Compound a-4a (1 g) was dissolved in 25 mL of a water/THF mixed solution (water:THF=1:4). Then, NaIO₄ (1.9 g) was added, followed by stirring for 5 min.

Next, a 2M hydrochloric acid aqueous solution (1 mL) was added, followed by stirring for 4 hours at room temperature. After confirming the disappearance of the raw material by TLC, water and ethyl acetate were added, and the organic layer was extracted. The obtained organic layer was washed with brine, dehydrated with sodium sulfate, filtered and concentrated.

The obtained mixture was recrystallized in Et₂O to obtain compound a-4b (800 mg).

(OH)₂B—CH₂—C(CH₂—CH═CH₂)₃ Formula (a-4b)

### Synthesis of Compound a-4c

Acetonitrile (380 mL), the above compound a-1c (31.3 g, 188 mmol), triphenylphosphine (64.3 g, 245 mmol) and carbon tetrabromide (33.9 g, 102 mmol) were added, followed by stirring at 90° C. After concentration, ethyl acetate/hexane was added, followed by stirring. After filtration and concentration, by distillation (70° C., 3 hPa), compound a-4c was obtained in an amount of 28.2 g.

Br—CH₂—C(CH₂—CH═CH₂)₃ Formula (a-4c)

### Synthesis of Compound a-4

Under nitrogen atmosphere, palladium acetate (Pd(OAc)₂) (20 mg), compound a-4b (1 g), potassium t-butoxide (KOt-Bu) (600 mg) and di-tert-butylmethyiphosphine (P(t-Bu)₂Me) (40 μL) were mixed.

Then, t-amyl alcohol (10 mL) was added, and compound a-4c (1 g) was added, followed by stirring at room temperature for 24 hours. The obtained mixture was dissolved in Et₂O (60 mL) and passed through silica gel (1 g), while adding Et₂O (100 mL).

The obtained mixture was purified by silica gel column chromatography to obtain compound a-4 (900 mg).

(CH₂═CH—CH₂)₃C—CH₂—CH₂—C(CH₂—CH═CH₂)₃ Formula (a-4)

NMR spectrum of compound a-4:

¹H-NMR (400 MHz, Chloroform-d) δ (ppm): 5.86-5.75 (m, 3H), 5.07-5.00 (m, 6H), 1.99 (d, J=7.3 Hz, 6H), 1.20 (s, 4H).

### Synthesis of Compound A-4

To the above compound a-4 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-4.

[Si(OCH₃)₃—CH₂—CH₂—CH₂]₃C—CH₂—CH₂—C[CH₂—CH₂—CH₂—Si(OCH₃)₃]₃ Formula (A-4)

### Synthesis Example 6: Synthesis of Compound A-5

### Synthesis of Compound a-5

### Synthesis of Compound a-5a

To magnesium (2.36 g, 97.2 mmol), THF (35 mL) and iodine (0.180 g, 0.71 mmol) were added, followed by stirring at room temperature. A THF (35 mL) solution of the above compound a-1 (14.0 g, 75.9 mmol) was added, followed by heating and refluxing for 2 hours to prepare a solution (0.80 M) of the following compound a-5a.

ClMg—CH₂—C(CH₂—CH═CH₂)₃ Formula (a-5a)

### Synthesis of Compound a-5b

1-Bromo-3-chloropropane (2.90 g, 18.3 mmol), 1-phenyl-1-propyne (0.220 g, 1.89 mmol) and CuCl₂ (0.051 g, 0.38 mmol) were added, followed by stirring at 0° C. The above compound a-5a (0.80M, 26.0 mL, 20.9 mmol) was added, followed by stirring. 1M Hydrochloric acid was added, followed by extraction with dichloromethane, and sodium sulfate was added. After filtration and concentration, by distillation (100° C., 3 hPa), the following compound a-5b was obtained in an amount of 3.29 g.

Cl—CH₂—CH₂—CH₂—CH₂—C(CH₂—CH═CH₂)₃ Formula (a-5b)

NMR spectrum of compound a-5b:

¹H-NMR (400 MHz, Chloroform-d) δ (ppm): 5.76 (ddt, J=16.6, 10.6, 7.4 Hz, 3H), 5.09-4.93 (m, 6H), 3.50 (t, J=6.7 Hz, 2H), 1.96 (dt J=7.4, 1.2 Hz, 6H), 1.76-1.61 (m, 2H), 1.45-1.29 (m, 2H), 1.24-1.08 (m, 2H).

### Synthesis of Compound a-5

Under a nitrogen atmosphere, to Zn Powder (0.98 g), nickel chloride (1.30 g) and compound a-5b (1 g), deionized water (1 mL) and HMPA (15 mL) were added, and in MW (53 W, 41 kHz), heating and stirring were conducted at 60° C. The obtained mixture was column purified with silica gel (40 g) (eluent hexane) to obtain compound a-5 (800 mg).

CH₂—CH₂—CH₂—CH₂—C(CH₂—CH═CH₂)₃ Formula (a-5)

### Synthesis of Compound A-5

To the above compound a-5 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-5.

CH₂—CH₂—CH₂—CH₂—C[CH₂—CH₂—CH₂—Si(OCH₃)₃]₃ Formula (A -5)

### Synthesis Example 7: Synthesis of Compound A-6

### Synthesis of Compound a-6

### Synthesis of Compound a-6a

Under a nitrogen atmosphere, manganese bromide (11 mg) and B₂pin₂ (1.6 g) were added. Then, DME (5 mL) and TMEDA (4% (v/v) solution in DME) (0.1 mL) were added.

Next, EtMgBr (3M solution in Et₂O) (2.2 mL) was dropwise added, and then, compound a-5b (1.2 g) was added. After stirring at room temperature for 4 hours, a 1M hydrochloric acid solution (20 mL) was added, and after extraction with Et₂O (120 mL), the organic layer was dehydrated with magnesium sulfate, filtered and concentrated.

The obtained mixture was purified by silica gel column chromatography to obtain compound a-6a (1 g).

Bpin-CH₂—CH₂—CH₂—CH₂—C(CH₂—CH═CH₂)₃ Formula (a-6a)

### Synthesis of Compound a-6b

Compound a-6a (1 g) was dissolved in 25 mL of a water/THF mixed solution (water:THF=1:4). Then, NaIO₄ (1.7 g) was added, followed by stirring for 5 min.

Next, a 2M hydrochloric acid solution (1 mL) was added, followed by stirring at room temperature for 4 hours. After confirming the disappearance of the raw material by TLC, water and ethyl acetate were added, and the organic layer was extracted. The obtained organic layer was washed with brine, dehydrated with sodium sulfate, filtered and concentrated.

The obtained mixture was recrystallized with Et₂O to obtain compound a-6b (700 mg).

(OH)₂B—CH₂—CH₂—CH₂—CH₂—C(CH₂—CH═CH₂)₃ Formula (a-6b)

### Synthesis of Compound a-6c

Compound a-5b (1 g), sodium formate (20 g) and tetrabutylammonium bromide (TBAB) (0.1 g) were mixed and stirred at 120° C. for 2 hours. Then, a 48% sodium hydroxide aqueous solution was slowly added. The obtained solution was extracted with ethyl acetate (100 mL). The organic layer was dehydrated with sodium sulfate, filtered and concentrated.

The obtained mixture was purified by silica gel column chromatography to obtain compound a-6c (700 mg).

HO—CH₂—CH₂—CH₂—CH₂—C(CH₂—CH═CH₂)₃ Formula (a-6c)

### Synthesis of Compound a-6d

Acetonitrile (380 mL), the above compound a-6c (31.3 g), triphenylphosphine (64.3 g, 245 mmol) and carbon tetrabromide (33.9 g, 102 mmol) were added and stirred at 90° C. After concentration, ethyl acetate/hexane was added, followed by stirring. After filtration and concentration, by distillation (70° C., 3 hPa), compound a-6d was obtained in an amount of 28.2 g.

Br—CH₂—CH₂—CH₂—CH₂—C(CH₂—CH═CH₂)₃ Formula (a-6d)

### Synthesis of Compound a-6

Under a nitrogen atmosphere, Pd(OAc)₂ (18 mg), compound a-6b (1 g), KOt-Bu (500 mg) and P(t-Bu)₂Me (40 μL) were mixed.

Thereafter, t-amyl alcohol (10 mL) was added, and then, compound a-6c (1 g) was added, followed by stirring at room temperature for 24 hours. The obtained mixture was dissolved in Et₂O (60 mL) and passed through silica gel (1 g) while Et₂O (100 mL) was added.

The obtained mixture was purified by silica gel column chromatography to obtain compound a-6 (1.2 g).

(CH₂═CH—CH₂)₃C—CH₂—CH₂—CH₂—CH₂—CH₂—CH₂—CH₂—CH₂—C(CH₂—CH═CH₂)₃ Formula (a-6)

### Synthesis of Compound A-6

To the above compound a-6 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., and the mixture was stirred at this temperature for 4 hours. Thereafter, a volatile matter was distilled off under reduced pressure to obtain compound A-6.

[Si(OCH₃)₃—CH₂—CH₂—CH₂]₃C—CH₂—CH₂—CH₂—CH₂—CH₂—CH₂—CH₂—CH₂—C[CH₂—CH₂—CH₂—Si(OCH₃)₃]₃ Formula (A-6)

### Synthesis Example 8: Synthesis of Compound A-7

### Synthesis of Compound a-7

To compound a-6d (5 g), potassium t-butoxide (1 g) and 18-Crown-6 (30 g) were added. After heating and stirring at 60° C. for 40 hours, a 1M hydrochloric acid solution (20 g) was added, followed by extraction with dichloromethane (50 g). The organic layer was dehydrated with magnesium sulfate, filtered and concentrated. The obtained product was purified by preparative GPC to obtain compound a-7 (3.8 g).

CH₂═CH—CH₂—CH₂—C(CH₂—CH═CH₂)₃ Formula (a-7)

### Synthesis of Compound A-7

To the above compound a-7 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-7.

Si(OCH₃)₃—CH₂—CH₂—CH₂—CH₂—C[CH₂—CH₂—CH₂—Si(OCH₃)₃]₃ Formula (A-7)

### Synthesis Example 9: Synthesis of Compound A-8

### Synthesis of Compound a-8

Under a nitrogen atmosphere, to Zn Powder (1.2 g), nickel chloride (1.70 g) and the following compound a-8a (1 g), deionized water (1 mL) and HMPA (15 mL) were added, and heating and stirring were conducted at 60° C. in MW (53 W, 41 kHz). The obtained mixture was column purified with silica gel (40 g) (eluent hexane) to obtain compound a-8 (400 mg).

Cl—CH₂—CH(CH₂—CH═CH₂)₂ Formula (a-8a)

CH₂—CH(CH₂—CH═CH₂)₂ Formula (a-8)

### Synthesis of Compound A-8

To the above compound a-8 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-8.

CH₃—CH[CH₂—CH₂—CH₂—Si(OCH₃)₃]₂ Formula (A-8)

### Synthesis Example 10: Synthesis of Compound A-9

### Synthesis of Compound a-9

### Synthesis of Compound a-9a

Under a nitrogen atmosphere, manganese bromide (18 mg) and B₂pin₂ (2.0 g) were added. Thereafter, DME (5 mL) and TMEDA (4% (v/v) solution in DME) (0.1 mL) were then added. Next, 2.2 mL of EtMgBr (3M solution in Et₂O) was dropwise added, and then, compound a-8a (1.5 g) was added.

After stirring at room temperature for 4 hours, a 1M hydrochloric acid solution (20 mL) was added, followed by extraction with Et₂O (120 mL), whereupon the organic layer was dehydrated with magnesium sulfate, filtered and concentrated. The obtained mixture was purified by silica gel column chromatography to obtain compound a-9a (900 mg).

Bpin-CH₂—CH(CH₂—CH═CH₂)₂ Formula (a-9a)

### Synthesis of Compound a-9b

Compound a-9a (1 g) was dissolved in 25 mL of a water/THF mixed solution (water:THF=1:4). Thereafter, NaIO₄ (1.7 g) was added, followed by stirring for 5 minutes. Then, a 2M hydrochloric acid solution (1 mL) was added, followed by stirring at room temperature for 4 hours. After confirming the disappearance of the raw material by TLC, water and ethyl acetate were added, and the organic layer was extracted. The obtained organic layer was washed with brine, dehydrated with sodium sulfate, filtered and concentrated.

The obtained mixture was recrystallized with Et₂O to obtain compound a-9b (700 mg).

(OH)₂B—CH₂—CH(CH₂—CH═CH₂)₂ Formula (a-9b)

### Synthesis of Compound a-9d

Acetonitrile (380 mL), the following compound a-9c (31.3 g), triphenylphosphine (64.3 g, 245 mmol) and carbon tetrabromide (33.9 g, 102 mmol) were added and stirred at 90° C. After concentration, ethyl acetate/hexane was added, followed by stirring. After filtration and concentration, by distillation (70° C., 3 hPa), compound a-9d was obtained in an amount of 28.2 g.

OH—CH₂—CH(CH₂—CH═CH₂)₂ Formula (a-9c)

Br—CH₂—CH(CH₂—CH═CH₂)₂ Formula (a-9d)

### Synthesis of Compound a-9

Under a nitrogen atmosphere, Pd(OAc)₂ (30 mg), compound a-9b (1.5 g), KOt-Bu (800 mg) and P(t-Bu)₂Me (80 μL) were mixed.

Thereafter, t-amyl alcohol (20 mL) was added, and then, compound a-6d (1 g) was added, followed by stirring at room temperature for 24 hours. The obtained mixture was dissolved in Et₂O (60 mL) and passed through silica gel (2 g) while Et₂O (100 mL) was added. The obtained mixture was purified by silica gel column chromatography to obtain compound a-9 (1 g).

(CH₂═CH—CH₂)₂CH—CH₂—CH₂—CH(CH₂—CH═CH₂)₂ Formula (a-9)

### Synthesis of Compound A-9

To the above compound a-9 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-9.

[Si(OCH₃)₃—CH₂—CH₂—CH₂]₂CH—CH₂—CH₂—CH[CH₂—CH₂—CH₂—Si(OCH₃)₃]₂ Formula (A-9)

### Synthesis Example 11: Synthesis of Compound A-10

### Synthesis of Compound a-10

Compound a-9d (1 g), dioxane (1 mL), dicyclohexylamine (Cy₂NH) (0.3 mL), KOt-Bu (0.1 g) and a dioxane solution of Pd(P(t-Bu)₂Me)₂ (30 mol %) (1 g) were added. The mixture was then stirred at room temperature for 24 hours.

The obtained mixture was dissolved in Et₂O (60 mL) and passed through silica gel (2 g) while adding Et₂O (100 mL). The obtained mixture was purified by silica gel column chromatography to obtain compound a-10 (500 mg).

CH₂═C(CH₂—CH═CH₂)₂ Formula (a-10)

### Synthesis of Compound A-10

To the above compound a-10 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-10.

Si(OCH₃)₃—CH₂—CH[CH₂—CH₂—CH₂—Si(OCH₃)₃]₂ Formula (A-10)

### Synthesis Example 12: Synthesis of Compound A-11

### Synthesis of Compound a-11

The compound described in Ex. 11-2 of WO2017/038830 was used as compound a-11.

NH₂—CH₂—C(CH₂—CH═CH₂)₃ Formula (a-11)

### Synthesis of Compound A-11

To the above compound a-11 (100 mg), platinum(0)-1,3-divinyl-1,1,3,3-tetramethyldisiloxane complex 2% in xylene (20 mg) and dichloromethane (1 g) was added, and trimethoxysilane (1 g) were added, whereupon the temperature was raised to 60° C., followed by stirring at this temperature for 4 hours. Thereafter, a volatile matter was distilled off under reduced pressure to obtain compound A-11.

NH₂—CH₂—C[CH₂—CH₂—CH₂—Si(OCH₃)₃]₃ Formula (A-11)

### Synthesis Example 13: Synthesis of Compound A-12

To a purified product (100 mg) of the following compound a-12 (NEOALLYL (registered trademark) P-30M: product name, manufactured by DAISO CO., LTD.), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-12.

OH—CH₂—C(CH₂—O—CH₂—CH=CH₂)₃ Formula (a-12)

OH—CH₂—C[CH₂—O—CH₂—CH₂—CH₂—Si(OCH₃)₃]₃ Formula (A-12)

### Synthesis Example 14: Synthesis of Compound A-13

### Synthesis of Compound a-13

The following compound a-13 was obtained in the same manner as the synthesis of the above compound a-1, except that compound a-12 was used instead of compound a-1c.

Cl—CH₂—C(CH₂—O—CH₂—CH═CH₂)₃ Formula (a-13)

### Synthesis of Compound A-13

To compound a-13 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-13.

Cl—CH₂—C[CH₂—O—CH₂—CH₂—CH₂—Si(OCH₃)₃]₃ Formula (A-13)

### Synthesis Example 15: Synthesis of Compound A-14

### Synthesis of Compound a-14

Under a nitrogen atmosphere, to Zn Powder (1.2 g), nickel chloride (1.70 g) and compound a-13 (1 g), deionized water (1 mL) and HMPA (15 mL) were added, followed by heating and stirring at 60° C. in MW (53 W, 41 kHz). The obtained mixture was column purified with silica gel (40 g) (eluent hexane) to obtain compound a-14 (700 mg).

Cl—CH₂—C(CH₂—O—CH₂—CH═CH₂)₃ Formula (a-14)

### Synthesis of Compound A-14

To the above compound a-14 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-14.

CH₃—C[CH₂—O—CH₂—CH₂—CH₂—Si(OCH₃)₃]₃ Formula (A-14)

### Synthesis Example 16: Synthesis of Compound A-15

### Synthesis of Compound a-15

### Synthesis of Compound a-15a

Acetonitrile (380 mL), the above compound a-12 (31.3 g), triphenylphosphine (64.3 g, 245 mmol) and carbon tetrabromide (33.9 g, 102 mmol) were added and stirred at 90° C. After concentration, ethyl acetate/hexane was added, followed by stirring. After filtration and concentration, by distillation (70° C., 3 hPa), compound a-15a was obtained in an amount of 28.2 g.

Br—CH₂—C(CH₂—O—CH₂—CH═CH₂)₃ Formula (a-15a)

### Synthesis of Compound a-15b

Under a nitrogen atmosphere, manganese bromide (30 mg) and B₂pin₂ (4.0 g) were added. Thereafter, DME (10 mL) and TMEDA (4% (v/v) solution in DME) (0.2 mL) were added. Next, 4 mL of EtMgBr (3M solution in Et₂O) was dropwise added, and then, compound a-13 (1.5 g) was added.

After stirring at room temperature for 4 hours, a 1M hydrochloric acid solution (40 mL) was added, followed by extraction with Et₂O (200 mL), whereupon the organic layer was dehydrated with magnesium sulfate, filtered and concentrated. The obtained mixture was purified by silica gel column chromatography to obtain compound a-15b (1 g).

Bpin-CH₂—C(CH₂—O—CH₂—CH═CH₂)₃ Formula (a-15b)

### Synthesis of Compound a-15c

Compound a-15b (1 g) was dissolved in 40 mL of a water/THF mixed solution (water:THF=1:4), and then, NaIO₄ (3 g) was added, followed by stirring for 5 minutes. Next, a 2M hydrochloric acid solution (1.5 mL) was added, followed by stirring at room temperature for 4 hours. After confirming the disappearance of the raw material by TLC, water and ethyl acetate were added, and the organic layer was extracted. The obtained organic layer was washed with brine, dehydrated with sodium sulfate, filtered and concentrated.

The obtained mixture was recrystallized with Et₂O to obtain compound a-15c (500 mg).

(OH)₂B—CH₂—C(CH₂—O—CH₂—CH═CH₂)₃ Formula (a-15c)

### Synthesis of Compound a-15

Under a nitrogen atmosphere, Pd(OAc)₂ (30 mg), compound a-15c (1.5 g), KOt-Bu (800 mg) and P(t-Bu)₂Me (80 μL) were mixed. Thereafter, t-amyl alcohol (20 mL) was added, and then, compound a-15a (1 g) was added, followed by stirring at room temperature for 24 hours.

The obtained mixture was dissolved in Et₂O (60 mL) and passed through silica gel (2 g) while adding Et₂O (100 mL). The obtained mixture was purified by silica gel column chromatography to obtain compound a-15 (1 g).

(CH₂═CH—CH₂—O—CH₂)₃C—CH₂—CH₂—C(CH₂—O—CH₂—CH═CH₂)₃ Formula (a-15)

### Synthesis of Compound A-15

To the above compound a-15 (100 mg), platinum(0)-1,3-divinyl-1,1,3,3-tetramethyldisiloxane complex 2% in xylene (20 mg) and dichloromethane (1 g) was added, and trimethoxysilane (1 g) was added, whereupon the temperature was raised to 60° C., followed by stirring at this temperature for 4 hours. Thereafter, a volatile matter was distilled off under reduced pressure to obtain compound A-15.

[Si(OCH₃)₃—CH₂—CH₂—CH₂—O—CH₂]₃C—CH₂—CH₂—C[CH₂—O—CH₂—CH₂—CH₂—Si(OCH₃)₃]₃ Formula (A-15)

### Ex. 1

Composition 1 was obtained by mixing fluorinated ether compound 3-1 and compound A-1 as a crosslinking agent, so as to be the molar ratios shown in Table 1.

In a molybdenum boat in a vacuum vapor deposition apparatus (VTR-350M manufactured by ULVAC KIKO, Inc.), 1.0 mL of composition 1 was filled as the vapor deposition source, and the inside of the vacuum vapor deposition apparatus was evacuated to at most 1×10⁻³ Pa. The boat in which composition 1 was placed was heated at a rate of at most 10° C./min, and at the time when the vapor deposition rate by a crystal oscillation type film thickness meter exceeded 1 nm/sec, the shutter was opened to start film formation on the surface of the base material (chemically strengthened glass). When the film thickness reached approximately 50 nm, the shutter was closed to finish the film formation on the surface of the base material. The base material on which composition 1 was deposited was heat treated at 200° C. for 30 minutes and washed with dichloropentafluoropropane (manufactured by AGC Inc., AK-225) to obtain a base material with a surface layer, having the surface layer on the surface of the base material.

### Ex. 2 to Ex. 22

The base material with a surface layer in each Ex. was obtained in the same manner as in Ex. 1, except that the type of the crosslinking agent, and the molar ratio of the fluorinated ether compound to the crosslinking agent, were changed as shown in Table 1.

### Evaluation Tests

The following evaluation tests were conducted using the base material with a surface layer in each of Ex. 1 to Ex. 22.

### Water Contact Angle (Initial)

The contact angle of approximately 2 μL of distilled water placed on the surface of the surface layer was measured at 20° C. by using a contact angle measuring device (DM-701 manufactured by Kyowa Interface Science Co., Ltd.). Measurements were conducted at three different locations on the surface of the surface layer, and the average value was calculated and adopted as the initial contact angle. The 2θ method was used to calculate the contact angle. The larger the initial contact angle, the higher the water repellency and the better the initial water contact angle.

### Water Contact Angle (After Abrasion Test)

With respect to the surface layer, a steel wool bonster (#0000) was reciprocated at a pressure of 98.07 kPa and a speed of 320 cm/min using a reciprocating traverse testing machine (manufactured by KNT) in accordance with JIS L0849:2013 (ISO 105-X12:2001). After 10,000 round-trip steel wool abrasion, the water contact angle of the surface layer was measured. The smaller the change in water contact angle before and after the abrasion test, the smaller the decrease in performance due to abrasion and the better the abrasion resistance.

### Results of the Evaluations

The results of the above evaluation tests are shown in Table 1.

TABLE 1

| | Fluorinated ether | | Crosslinking | | | |
|---|---|---|---|---|---|---|
| | compound | | agent | | | |
| | | Content | | Content | Water contact angle (degree) | |
| | Type | (mol%) | Type | (mol%) | Initial | After abrasion test |
| Ex. 1 | 3-1 | 90 | A-1 | 10 | 115 | 110 |
| Ex. 2 | 3-1 | 90 | A-2 | 10 | 115 | 110 |
| Ex. 3 | 3-1 | 90 | A-3 | 10 | 113 | 107 |
| Ex. 4 | 3-1 | 90 | A-4 | 10 | 115 | 113 |
| Ex. 5 | 3-1 | 90 | A-5 | 10 | 115 | 110 |
| Ex. 6 | 3-1 | 90 | A-6 | 10 | 115 | 112 |
| Ex. 7 | 3-1 | 90 | A-7 | 10 | 115 | 111 |
| Ex. 8 | 3-1 | 90 | A-8 | 10 | 115 | 100 |
| Ex. 9 | 3-1 | 90 | A-9 | 10 | 115 | 111 |
| Ex. 10 | 3-1 | 90 | A-10 | 10 | 115 | 110 |
| Ex. 11 | 3-1 | 90 | A-11 | 10 | 112 | 111 |
| Ex. 12 | 3-1 | 90 | A-12 | 10 | 108 | 100 |
| Ex. 13 | 3-1 | 90 | A-13 | 10 | 111 | 106 |
| Ex. 14 | 3-1 | 90 | A-14 | 10 | 110 | 105 |
| Ex. 15 | 3-1 | 90 | A-15 | 10 | 108 | 106 |
| Ex. 16 | 3-1 | 99.9 | A-4 | 0.1 | 115 | 102 |
| Ex. 17 | 3-1 | 99.5 | A-4 | 0.5 | 115 | 114 |
| Ex. 18 | 3-1 | 99 | A-4 | 1 | 115 | 115 |
| Ex. 19 | 3-1 | 95 | A-4 | 5 | 115 | 113 |
| Ex. 20 | 3-1 | 80 | A-4 | 20 | 115 | 106 |
| Ex. 21 | 3-1 | 70 | A-4 | 30 | 115 | 100 |
| Ex. 22 | 3-1 | 100 | — | — | 115 | 92 |

As shown in Table 1, it has been confirmed that by using a composition comprising a specific fluorinated ether compound and a crosslinking agent having a plurality of reactive silyl groups and no poly(oxyfluoroalkylene) chain, it is possible to form a surface layer excellent in initial water contact angle and also excellent in abrasion resistance (Ex. 1 to Ex. 21).

### INDUSTRIAL APPLICABILITY

The composition of the present invention can be used for various applications. For example, it can be used for display input devices such as touch panels; transparent glass or transparent plastic components, lenses for glasses, etc., antifouling components for kitchens; water and moisture repellent and antifouling components for electronic equipment, heat exchangers, batteries, etc.; antifouling components for toiletries; components requiring liquid repellency while conducting; water repellent, waterproof, and gliding components for heat exchangers; and components for low surface abrasion such as vibrating sieves and inside cylinders. More specific examples of use include: front protection panels of displays, antireflection panels, polarizing panels, antiglare panels, or their surfaces treated with antireflection coatings, various devices having display input devices that are operated on the screen with a person's finger or palm, such as touch panel sheets or touch panel displays of devices such as cell phones (e.g. smartphones), portable information terminals, game consoles, remote controls, etc. (e.g. glass or film used for the display section, etc., as well as glass or film used for exterior parts other than the display section). In addition to the above, decorative construction materials for water areas such as toilets, baths, washrooms, and kitchens; waterproof materials for circuit boards; water repellent, waterproof, and water-sliding materials for heat exchangers; water repellent materials for solar cells; waterproof and water repellent materials for printed circuit boards; waterproof and water repellent materials for electronic equipment housings and electronic components; materials to improve insulation properties of power transmission lines; waterproof and waterproof materials for various filters; waterproof components for radio wave absorbers and sound absorbers; antifouling components for baths, kitchen appliances and toiletries; low surface abrasion components for vibrating sieves and cylinder interiors; components for machinery parts, vacuum equipment parts, bearing parts, and transportation equipment parts such as automobiles; and surface protection components for tools, etc. may be mentioned.

This application is a continuation of PCT Application No. PCT/JP2022/008607, filed on Mar. 1, 2022, which is based upon and claims the benefit of priority from Japanese Patent Application No. 2021-035376 filed on Mar. 5, 2021. The contents of those applications are incorporated herein by reference in their entireties.

What is claimed is:

1. A composition characterized by comprising a fluorinated ether compound having a poly(oxyfluoroalkylene) chain and a reactive silyl group, and a crosslinking agent having a plurality of reactive silyl groups and no poly(oxyfluoroalkylene) chain.

2. The composition according to claim 1, wherein the number of the reactive silyl groups in the crosslinking agent is from 2 to 8.

3. The composition according to claim 1, wherein the crosslinking agent is a compound represented by the formula (A):
R^{a1}-L^{a1}-C(—Y^{a1}-T^{a1})ₘ₁(—R^{a2})₃₋ₘ₁ Formula (A)
in the formula (A),
R^{a1} is a hydrogen atom, a halogen atom, an amino group, a hydroxy group, a reactive silyl group, -L^{a2}-C(—Y^{a2}-T^{a2})ₘ₂(—R^{a3})₃₋ₘ₂, R^{a4}C(O)NH—, R^{a4}S(O)₂O—, R^{a4}C(O)O— or a thiol group,
L^{a1} and L^{a2} are each independently a C₁₋₁₀ alkylene group which may have a fluorine atom,
Y^{a1} and Y^{a2} are each independently a C₂₋₁₀ alkylene group which may have a fluorine atom or an etheric oxygen atom between carbon-carbon atoms,
T^{a1} and T^{a2} are each independently a reactive silyl group,
R^{a2} and R^{a3} are each independently a C₁₋₁₀ alkyl group which may have a fluorine atom, or a hydrogen atom,
R^{a4} is a C₁₋₅ alkyl group which may have a fluorine atom,
m1 and m2 are each independently an integer of from 1 to 3,
provided that when m1 is 1, R^{a1} is a reactive silyl group or -L^{a2}-C(—Y^{a2}-T^{a2})ₘ₂(—R^{a3})₃₋ₘ₂.

4. The composition according to claim 3, wherein in the formula (A),
L^{a1} is a C₁₋₁₀ alkylene group not having a fluorine atom,
Y^{a1} is a C₂₋₁₀ alkylene group not having a fluorine atom or an etheric oxygen atom, and
R^{a2} is a C₁₋₁₀ alkyl group not having a fluorine atom, or a hydrogen atom.

5. The composition according to claim 3, wherein in the formula (A), m1 is 3.

6. The composition according to claim 3, wherein in the formula (A), R^{a1} is -L^{a2}-C(—Y^{a2}-T^{a2})ₘ₂(—R^{a3})₃₋ₘ₂.

7. The composition according to claim 6, wherein in the formula (A),
L^{a2} is a C₁₋₁₀ alkylene group not having a fluorine atom,
Y^{a2} is a C₂₋₁₀ alkylene group not having a fluorine atom or an etheric oxygen atom and
R^{a3} is a C₁₋₁₀ alkyl group not having a fluorine atom, or a hydrogen atom.

8. The composition according to claim 6, wherein in the formula (A), m2 is 3.

9. The composition according to claim 1, wherein the molar ratio of the content of the crosslinking agent to the content of the fluorinated ether compound is from 0.0010 to 0.3000.

10. The composition according to claim 1, wherein the poly(oxyfluoroalkylene) chain contains a repeating unit represented by the following formula (1):
(OX) Formula (1)
(X is a fluoroalkylene group having at least one fluorine atom).

11. The composition according to claim 1, wherein the reactive silyl group is a group represented by the following formula (2):
—Si(R)ₙL₃₋ₙ Formula (2)
(R is a monovalent hydrocarbon group; L is a hydrolyzable group or a hydroxy group; and n is an integer of from 0 to 2).

12. The composition according to claim 1, wherein the fluorinated ether compound is a compound represented by the following formula (3):
[A-(OX)ₘ—O—]ⱼZ[—Si(R)ₙL₃₋ₙ]_{g} Formula (3)
(A is a perfluoroalkyl group or -Q[-Si(R)ₙL₃₋ₙ]ₖ; X is a fluoroalkylene group having at least one fluorine atom; R is a monovalent hydrocarbon group; L is a hydrolyzable group or a hydroxy group; m is an integer of at least 2; n is an integer of from 0 to 2; j is an integer of at least 1; g is an integer of at least 1; and k is an integer of from 1 to 10).

13. A base material with a surface layer, characterized by comprising a base material and a surface layer formed from the composition as defined in claim 1 on the base material.

14. A method for producing a base material with a surface layer, comprising forming a surface layer on the base material by a dry coating method or a wet coating method using the composition as defined in claim 1.
